(19) United States
(12) Patent Application Publication
(10) Pub. No.: US 2025/0068923 A1
(43) Pub. Date: Feb. 27, 2025

(54) MACHINE LEARNING DEVICE, ESTIMATION SYSTEM, TRAINING METHOD, AND RECORDING MEDIUM

(71) Applicant: NEC CORPORATION, Minato-ku, Tokyo (JP)

(72) Inventors: Kenichiro FUKUSHI, Tokyo (JP); Hiroshi KAJITANI, Tokyo (JP); Fumiyuki NIHEY, Tokyo (JP); Chenhui HUANG, Tokyo (JP); Kazuki IHARA, Tokyo (JP); Zhenwei WANG, Tokyo (JP); Yoshitaka NOZAKI, Tokyo (JP); Kentaro NAKAHARA, Tokyo (JP)

(73) Assignee: NEC CORPORATION, Minato-ku, Tokyo (JP)

(21) Appl. No.: 18/726,466

(22) PCT Filed: Jan. 24, 2022
(86) PCT No.: PCT/JP2022/002327

§ 371 Date: Jul. 3, 2024

(51) Int. Cl. G06N 3/094; G06N 3/045

(52) U.S. Cl. CPC G06N 3/094; G06N 3/045

(57) ABSTRACT

A machine learning device that trains a first encoding model for encoding first sensor data into first code, a second encoding model for encoding second sensor data into second code, and an estimation model for making estimation using the first code and the second code such that an estimation result from the estimation model conforms to correct answer data, trains a first adversarial estimation model that outputs an estimated value of the second code in response to the input of the first code such that the estimated value of the second code estimated by the first adversarial estimation model conforms to the second code outputted from the second encoding model, and trains the first encoding model such that the estimated value of the second code estimated by the first adversarial estimation model does not conform to the second code outputted from the second encoding model.

### TECHNICAL FIELD

The present disclosure relates to a machine learning device or the like that executes machine learning using measurement data by a sensor.

### BACKGROUND ART

With the spread of the Internet of Things (IoT) technology, various types of information regarding people and objects can be collected from various IoT devices. In fields such as medical care, healthcare, and security, attempts have been made to utilize information collected by IoT devices. For example, if machine learning is applied to information collected by an IoT device, the information can be used for applications such as health state estimation and personal authentication. In IoT device, advanced power saving is required. In the total power consumption of the IoT device, the ratio of power consumption consumed for communication is relatively large. Thus, in the IoT device, there is a strong restriction on communication. Thus, it is difficult for the IoT device to transmit high-frequency and large-capacity data.

PTL 1 discloses a data analysis system that analyzes observation data observed by an instrument such as an IoT device. In the system of PTL 1, the instrument inputs observation data to an input layer of a learned neural network and performs processing up to a predetermined intermediate layer. The learned neural network is configured in such a way that the number of nodes in the predetermined intermediate layer is smaller than the number of nodes in an output layer. Under a predetermined constraint, the learned neural network is learned in advance in such a way that an overlap of probability distributions of low-dimensional observation data for observation data having different analysis results is reduced as compared with that in a case where there is no predetermined constraint. The instrument transmits a result processed up to the predetermined intermediate layer to the device as the low-dimensional observation data. The device analyzes the observation data observed by the instrument by inputting the received low-dimensional observation data to an intermediate layer next to the predetermined intermediate layer and performing processing.

### CITATION LIST

### Patent Literature

PTL 1: WO 2019/203232 A1

### SUMMARY OF INVENTION

### Technical Problem

In the method of PTL 1, the low-dimensional observation data processed up to the predetermined intermediate layer is transmitted from the instrument to the device. Thus, according to the method of PTL 1, the amount of data at the time of transmitting data from the instrument to the device can be reduced. For example, in the method of PTL 1, observation data observed by a plurality of instruments can be analyzed by connecting a plurality of instruments to the device. However, when the method of PTL 1 is extended to a plurality of instruments, since the neural network of each instrument is independently trained, there is a possibility that the low-dimensional observation data of each device includes redundant information. When the low-dimensional observation data includes redundant information and thus data is duplicated, the communication efficiency decreases in a situation where the communication amount is limited.

An object of the present disclosure is to provide a machine learning device and the like that can eliminate redundancy of codes derived from sensor data measured by a plurality of measuring instruments and efficiently reduce dimensions of sensor data.

### Solution to Problem

A machine learning device according to one aspect of the present disclosure includes an acquisition unit that acquires a training data set including first sensor data measured by a first measuring device, second sensor data measured by a second measuring device, and correct answer data, an encoding unit that encodes the first sensor data into a first code using a first encoding model and encoding the second sensor data into a second code using a second encoding model, an estimation unit that inputs the first code and the second code to an estimation model and outputting an estimation result output from the estimation model, an adversarial estimation unit that inputs the first code to a first adversarial estimation model that outputs an estimated value of the second code in response to input of the first code and estimating the estimated value of the second code, and a machine learning processing unit that trains the first encoding model, the second encoding model, the estimation model, and the first adversarial estimation model by machine learning. The machine learning processing unit trains the first encoding model, the second encoding model, and the estimation model in such a way that an estimation result of the estimation model matches the correct answer data, trains the first adversarial estimation model in such a way that the estimated value of the second code by the first adversarial estimation model matches the second code output from the second encoding model, and trains the first encoding model in such a way that the estimated value of the second code by the first adversarial estimation model does not match the second code output from the second encoding model.

A training method according to one aspect of the present disclosure includes acquiring a training data set including first sensor data measured by a first measuring device, second sensor data measured by a second measuring device, and correct answer data, encoding the first sensor data into a first code using a first encoding model and encoding the second sensor data into a second code using a second encoding model, inputting the first code and the second code to an estimation model and outputting an estimation result output from the estimation model, inputting the first code to a first adversarial estimation model that outputs an estimated value of the second code in response to input of the first code and estimating the estimated value of the second code, training the first encoding model, the second encoding model, and the estimation model in such a way that an estimation result of the estimation model matches the correct answer data, training the first adversarial estimation model in such a way that the estimated value of the second code by the first adversarial estimation model matches the second code output from the second encoding model, and training the first encoding model in such a way that the estimated value of the second code by the first adversarial estimation model does not match the second code output from the second encoding model.

A program according to one aspect of the present disclosure causes a computer to execute a process of acquiring a training data set including first sensor data measured by a first measuring device, second sensor data measured by a second measuring device, and correct answer data, a process of encoding the first sensor data into a first code using a first encoding model and encoding the second sensor data into a second code using a second encoding model, a process of inputting the first code and the second code to an estimation model and outputting an estimation result output from the estimation model, a process of inputting the first code to a first adversarial estimation model that outputs an estimated value of the second code in response to input of the first code and estimating the estimated value of the second code, a process of training the first encoding model, the second encoding model, and the estimation model in such a way that an estimation result of the estimation model matches the correct answer data, a process of training the first adversarial estimation model in such a way that the estimated value of the second code by the first adversarial estimation model matches the second code output from the second encoding model, and a process of training the first encoding model in such a way that the estimated value of the second code by the first adversarial estimation model does not match the second code output from the second encoding model. Advantageous Effects of Invention

According to the present disclosure, it is possible to provide a machine learning device and the like that can eliminate redundancy of codes derived from sensor data measured by a plurality of measuring instruments and efficiently reduce dimensions of sensor data.

### BRIEF DESCRIPTION OF DRAWINGS

FIG. 1 is a block diagram illustrating an example of a configuration of a machine learning device according to a first example embodiment.

FIG. 2 is a conceptual diagram for describing an example of a model group included in the machine learning device according to the first example embodiment.

FIG. 3 is a conceptual diagram for describing accumulation of training data that is a machine learning target of the machine learning device according to the first example embodiment.

FIG. 4 is a conceptual diagram for describing an example of training of the model group by the machine learning device according to the first example embodiment.

FIG. 5 is a flowchart for describing an example of operation of the machine learning device according to the first example embodiment.

FIG. 6 is a flowchart for describing an example of estimation processing by the machine learning device according to the first example embodiment.

FIG. 7 is a flowchart for describing an example of training processing by the machine learning device according to the first example embodiment.

FIG. 8 is a block diagram illustrating an example of a configuration of a machine learning device according to a second example embodiment.

FIG. 9 is a conceptual diagram for describing an example of a model group included in the machine learning device according to the second example embodiment.

FIG. 10 is a conceptual diagram for describing an example of training of the model group by the machine learning device according to the first example embodiment.

FIG. 11 is a flowchart for describing an example of operation of the machine learning device according to the second example embodiment.

FIG. 12 is a flowchart for describing an example of estimation processing by the machine learning device according to the second example embodiment.

FIG. 13 is a flowchart for describing an example of training processing by the machine learning device according to the second example embodiment.

FIG. 14 is a block diagram illustrating an example of a configuration of a machine learning device according to a third example embodiment.

FIG. 15 is a block diagram illustrating an example of a configuration of an estimation system according to a fourth example embodiment.

FIG. 16 is a conceptual diagram illustrating an arrangement example of a first measuring device of the estimation system according to the fourth example embodiment.

FIG. 17 is a block diagram illustrating an example of a configuration of the first measuring device included in the estimation system according to the fourth example embodiment.

FIG. 18 is a conceptual diagram illustrating an arrangement example of a second measuring device included in the estimation system according to the fourth example embodiment.

FIG. 19 is a block diagram illustrating an example of a configuration of the second measuring device included in the estimation system according to the fourth example embodiment.

FIG. 20 is a block diagram illustrating an example of a configuration of an estimation device included in the estimation system according to the fourth example embodiment.

FIG. 21 is a conceptual diagram for describing estimation of a body condition by the estimation system according to the fourth example embodiment.

FIG. 22 is a conceptual diagram illustrating an example in which the estimation result of the body condition by the estimation system according to the fourth example embodiment is displayed on a screen of a mobile terminal.

FIG. 23 is a flowchart for describing an example of operation of the first measuring device included in the estimation system according to the fourth example embodiment.

FIG. 24 is a flowchart for describing an example of operation of the second measuring device included in the estimation system according to the fourth example embodiment.

FIG. 25 is a flowchart for describing an example of operation of the estimation device included in the estimation system according to the fourth example embodiment.

FIG. 26 is a block diagram illustrating an example of a hardware configuration that achieves the machine learning device and the estimation device of each example embodiment.

### EXAMPLE EMBODIMENTS

Hereinafter, example embodiments of the present invention will be described with reference to the drawings. However, although the example embodiments to be described below are technically preferably limited in order to carry out the present invention, the scope of the invention is not limited to the following. In all the drawings used in the following description of the example embodiment, the same reference numerals are given to similar parts unless there is a particular reason. In the following example embodiments, repeated description of similar configurations and operations may be omitted.

### First Example Embodiment

First, a machine learning device according to a first example embodiment will be described with reference to the drawings. The machine learning device of the present example embodiment learns data collected by an Internet of Things (IoT) device (also referred to as a measuring device). The measuring device includes at least one sensor. For example, the measuring device is an inertial measuring device including an acceleration sensor, an angular velocity sensor, and the like. For example, the measuring device is an activity meter including an acceleration sensor, an angular velocity sensor, a pulse sensor, a temperature sensor, and the like. In the present example embodiment, a wearable device worn on a body will be described as an example.

The machine learning device of the present example embodiment learns sensor data (raw data) related to a physical activity measured by a plurality of measuring devices. For example, the machine learning device of the present example embodiment learns sensor data related to a physical quantity related to movement of a foot, a physical quantity/biological data related to a physical activity, or the like. The machine learning device of the present example embodiment constructs a model for estimating a body condition (estimation result) in response to input of sensor data by machine learning using the sensor data. The method of the present example embodiment can be applied to analysis of time-series data of sensor data, an image, and the like.

### Configuration

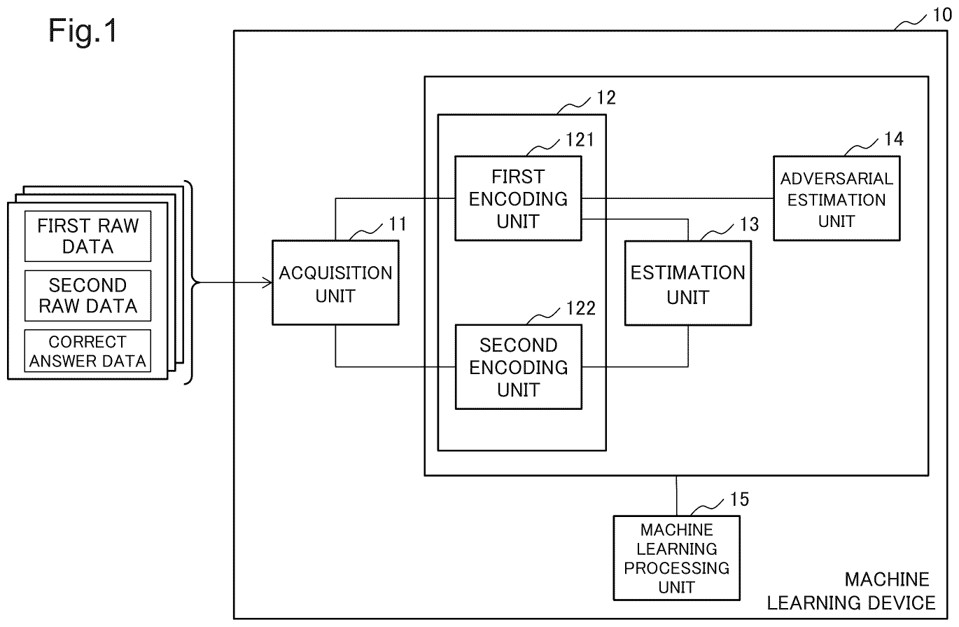

FIG. 1 is a block diagram illustrating an example of a configuration of a machine learning device 10 according to the present example embodiment. The machine learning device 10 includes an acquisition unit 11, an encoding unit 12, an estimation unit 13, an adversarial estimation unit 14, and a machine learning processing unit 15. The encoding unit 12 includes a first encoding unit 121 and a second encoding unit 122.

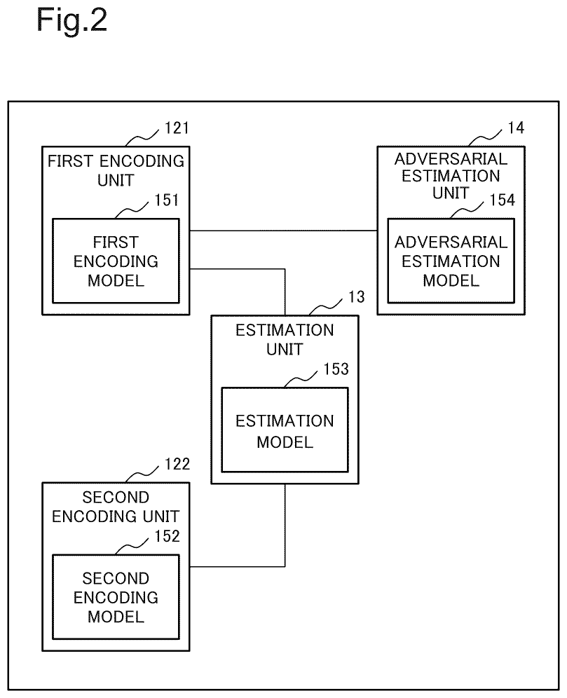

FIG. 2 is a block diagram for describing a model constructed by the machine learning device 10. In FIG. 2, the acquisition unit 11 and the machine learning processing unit 15 are omitted. The first encoding unit 121 includes a first encoding model 151. The second encoding unit 122 includes a second encoding model 152. The estimation unit 13 includes an estimation model 153. The adversarial estimation unit 14 includes an adversarial estimation model 154 (also referred to as a first adversarial estimation model). The first encoding model 151, the second encoding model 152, the estimation model 153, and the adversarial estimation model 154 are also collectively referred to as a model group. Details of the first encoding model 151, the second encoding model 152, the estimation model 153, and the adversarial estimation model 154 will be described later.

The acquisition unit 11 acquires a plurality of data sets (also referred to as training data sets) used for model construction. For example, the acquisition unit 11 acquires a training data set from a database (not illustrated) in which the training data set is accumulated. The training data set includes a data set combining first sensor data (first raw data), second sensor data (second raw data), and correct answer data. The first raw data and the second raw data are sensor data measured by different measuring devices. For example, the correct answer data is a body condition associated to the first raw data and the second raw data. The acquisition unit 11 acquires a training data set including the first raw data, the second raw data, and the correct answer data corresponding to each other from a plurality of training data sets included in the training data set.

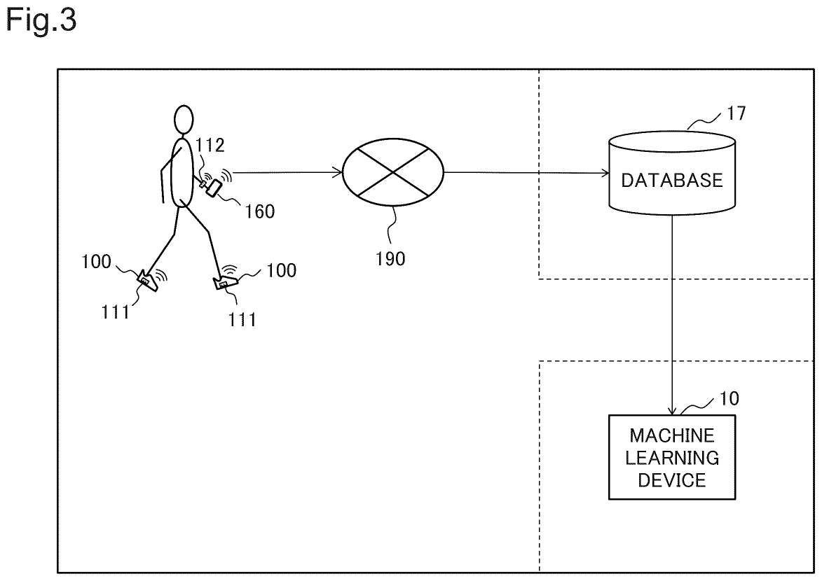

FIG. 3 is a conceptual diagram for describing an example of collection of a training data set. FIG. 3 illustrates an example in which a person walking (also referred to as a subject) wears a plurality of wearable devices (measuring devices). It is assumed that the body condition (correct answer data) of an estimation target is verified in advance. For example, the training data set is obtained from a plurality of subjects. A model constructed using training data sets acquired from a plurality of subjects is versatile. For example, the training data set is acquired from a particular subject. A model constructed using a training data set acquired from a specific subject enables highly accurate estimation for the specific subject even without versatility.

The subject in FIG. 3 wears footwear 100 on which a first measuring device 111 is installed. That is, the first measuring device 111 is worn on the foot portion of the subject in FIG. 3. For example, the first measuring device 111 includes a sensor that measures acceleration or angular velocity. The first measuring device 111 generates first sensor data (first raw data) related to acceleration or angular velocity measured in response to a gait of the subject. The first measuring device 111 transmits the generated first raw data. The first raw data transmitted from the first measuring device 111 is received by the mobile terminal 160 carried by the subject.

A second measuring device 112 is worn on a wrist of the subject in FIG. 3. For example, the second measuring device 112 includes a sensor that measures acceleration, angular velocity, pulse, or temperature. The second measuring device 112 generates second sensor data (second raw data) related to the acceleration, the angular velocity, the pulse, and the body temperature measured in response to the activity of the walking person. The second measuring device 112 transmits the generated second raw data. The second raw data transmitted from the second measuring device 112 is received by the mobile terminal 160 carried by the subject.

For example, the first measuring device 111 and the second measuring device 112 transmit the first raw data and the second raw data to the mobile terminal 160 via wireless communication. For example, the first measuring device 111 and the second measuring device 112 transmit raw data to the mobile terminal 160 via a wireless communication function (not illustrated) conforming to a standard such as Bluetooth (registered trademark) or WiFi (registered trademark). The communication functions of the first measuring device 111 and the second measuring device 112 may conform to a standard other than Bluetooth (registered trademark) or WiFi (registered trademark). For example, the first measuring device 111 and the second measuring device 112 may transmit raw data to the mobile terminal 160 via a wire such as a cable.

A data collection application (not illustrated) installed in the mobile terminal 160 generates a training data set by associating the first raw data and the second raw data with the body condition (correct answer data) of the subject. For example, the data collection application generates the training data set by associating the first raw data and the second raw data measured at the same timing with the body condition (correct answer data) of the subject. The mobile terminal 160 transmits the training data set to a database 17 constructed in a cloud or a server via a network 190 such as the Internet. The communication method of the mobile terminal 160 is not particularly limited. The transmitted training data set is accumulated in the database 17. For example, the mobile terminal 160 may be configured to transmit the first raw data, the second raw data, and the body condition of the subject to an estimation device implemented in a cloud or a server. In this case, it is only required to be configured to generate the training data set by a data collection application constructed in the cloud or the server. The machine learning device 10 acquires the training data set accumulated in the database 17.

The first raw data and the second raw data may be subjected to some preprocessing. For example, the first raw data and the second raw data may be subjected to preprocessing such as noise removal by a low-pass filter, a high-pass filter, or the like. For example, the first raw data and the second raw data may be subjected to preprocessing such as outlier removal or missing value interpolation. For example, the first raw data and the second raw data may be subjected to preprocessing such as frequency conversion, integration, and differentiation. For example, the first raw data and the second raw data may be subjected to statistical processing such as averaging or distributed calculation as preprocessing. For example, when the first raw data and the second raw data are time-series data, cutting out of a predetermined section may be performed as preprocessing. For example, when the first raw data and the second raw data are image data, clipping of a predetermined region may be performed as preprocessing. The preprocessing performed on the first raw data and the second raw data is not limited to those listed herein.

For example, the training data set is information obtained by combining sensor data (first raw data) regarding movement of the foot, sensor data (second raw data) related to the physical activity, and the body condition (correct answer data) of the subject. For example, the first raw data includes sensor data of acceleration, angular velocity, and the like. For example, the first raw data may include a velocity, a position (trajectory), an angle, and the like obtained by integrating the acceleration and the angular velocity. For example, the second raw data includes sensor data of acceleration, angular velocity, pulse, body temperature, and the like. For example, the second raw data may include data calculated using acceleration, angular velocity, pulse, body temperature, and the like. For example, the body condition (correct answer data) includes the body condition of the subject such as the degree of pronation/supination of the foot, the progress status of hallux valgus, or the risk of falling down. For example, the body condition may include a score related to the body condition of the subject. The training data set acquired by the acquisition unit 11 is not particularly limited as long as it is information obtained by combining an explanatory variable (first raw data and second raw data) and an objective variable (correct answer data).

The encoding unit 12 acquires the first raw data and the second raw data from the acquisition unit 11. In the encoding unit 12, the first encoding unit 121 encodes the first raw data. The first raw data encoded by the first encoding unit 121 is a first code. The encoding unit 12 encodes the second raw data by the second encoding unit 122. The second raw data encoded by the second encoding unit 122 is a second code.

The first encoding unit 121 acquires the first raw data. The first encoding unit 121 inputs the acquired first raw data to the first encoding model 151. The first encoding model 151 outputs the first code in response to the input of the first raw data. The first code includes features of the first raw data. That is, the first encoding unit 121 encodes the first raw data to generate the first code including the features of the first raw data. For example, the first encoding unit 121 encodes the feature amount extracted from the first raw data to generate the first code including the feature used for estimating the body condition. For example, the first encoding unit 121 encodes the feature amount extracted from the first raw data to generate the first code. The first code includes a feature used for estimation of a score related to the body condition of the subject.

The second encoding unit 122 acquires the second raw data. The second encoding unit 122 inputs the acquired second raw data to the second encoding model 152. The second encoding model 152 outputs the second code in response to the input of the second raw data. The second code includes features of the second raw data. That is, the second encoding unit 122 encodes the second raw data to generate the second code including the features of the second raw data. For example, the second encoding unit 122 encodes the feature amount extracted from the second raw data to generate the second code including the feature used for estimating the body condition. For example, the second encoding unit 122 encodes the feature amount extracted from the second raw data to generate the second code. The second code includes a feature used for estimation of a score related to the body condition of the subject.

The first raw data and the second raw data may include overlapping information. For example, both the first measuring device 111 and the second measuring device 112 measure acceleration and angular velocity. Thus, the first raw data and the second raw data have overlapping information regarding acceleration and angular velocity. For example, when the subject walks fast, the gait velocity calculated based on the first raw data increases. When the subject walks fast, the magnitude and fluctuation of the pulse included in the second raw data increase due to an increase in the heart rate. Thus, the first raw data and the second raw data have overlapping information regarding an increase in heart rate due to an increase in gait velocity. For example, there is a body condition that can be estimated using the first raw data measured by the first measuring device 111 installed on the footwear 100 of one foot. Regarding such a body condition, information regarding the first raw data transmitted from the first measuring device 111 installed on the footwear 100 of the left foot and the first measuring device 111 installed on the footwear 100 of the right foot overlaps. In the present example embodiment, a model for excluding overlapping information that may be included in the first raw data and the second raw data at the stage of encoding is constructed.

For example, the first encoding model 151 and the second encoding model 152 output time-series data (code) of 10 Hz in response to input of time-series data (raw data) measured at a cycle of 100 hertz (Hz). For example, the first encoding model 151 and the second encoding model 152 output time-series data (code) whose data amount has been reduced by averaging or denoising in response to input of time-series data corresponding to raw data. For example, the first encoding model 151 outputs image data (code) of 7×7 pixels in response to input of image data (raw data) of 28×28 pixels. The code only needs to include features of having a smaller data amount than the raw data and enabling estimation of correct answer data corresponding to the raw data. The data capacity, the data format, and the like of the code are not limited.

The estimation unit 13 acquires the first code and the second code from the encoding unit 12. The estimation unit 13 inputs the acquired first code and second code to the estimation model 153. The estimation model 153 outputs an estimation result regarding the body condition of the subject in response to the input of the first code and the second code. That is, the estimation unit 13 estimates the body condition of the subject using the first code and the second code. The estimation unit 13 outputs the estimation result regarding the body condition of the subject. The estimation result by the estimation unit 13 is compared with the correct answer data of the body condition of the subject by the machine learning processing unit 15.

The adversarial estimation unit 14 acquires the first code from the encoding unit 12. The adversarial estimation unit 14 inputs the acquired first code to the adversarial estimation model 154. The adversarial estimation model 154 outputs the second code in response to the input of the first code. That is, the adversarial estimation unit 14 estimates the second code using the first code. An estimated value of the second code by the adversarial estimation unit 14 may include a common point with the first code. The estimated value of the second code by the adversarial estimation unit 14 is compared with the second code encoded by the second encoding unit 122 by the machine learning processing unit 15.

For example, the first encoding model 151, the second encoding model 152, the estimation model 153, and the adversarial estimation model 154 include a structure of deep neural network (DNN). For example, the first encoding model 151, the second encoding model 152, the estimation model 153, and the adversarial estimation model 154 include a structure of convolutional neural network (CNN). For example, the first encoding model 151, the second encoding model 152, the estimation model 153, and the adversarial estimation model 154 include a structure of recurrent neural network (RNN). The structures of the first encoding model 151, the second encoding model 152, the estimation model 153, and the adversarial estimation model 154 are not limited to DNN, CNN, and RNN. The first encoding model 151, the second encoding model 152, the estimation model 153, and the adversarial estimation model 154 are trained by machine learning by the machine learning processing unit 15.

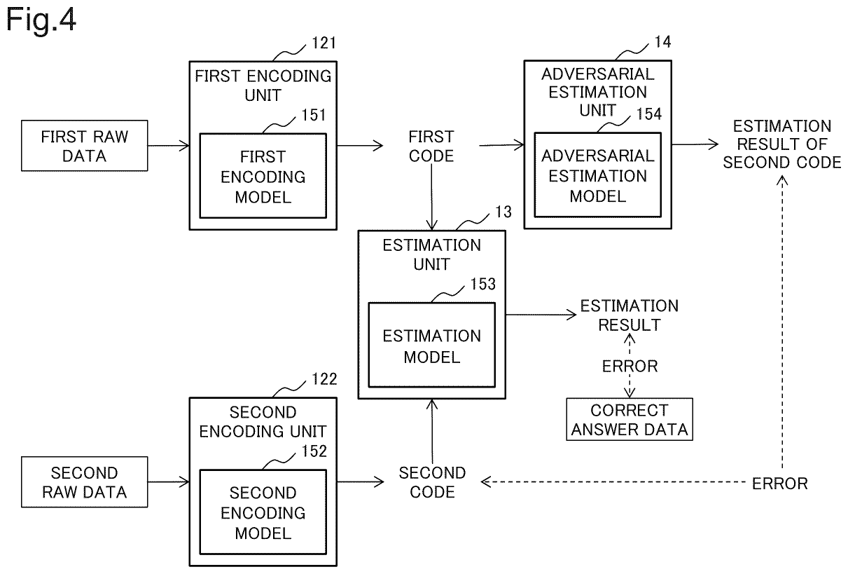

The machine learning processing unit 15 trains a model group of the first encoding model 151, the second encoding model 152, the estimation model 153, and the adversarial estimation model 154 by machine learning. FIG. 4 is a conceptual diagram for describing training of the first encoding model 151, the second encoding model 152, the estimation model 153, and the adversarial estimation model 154 by the machine learning processing unit 15. In FIG. 4, the acquisition unit 11 and the machine learning processing unit 15 are omitted.

The machine learning processing unit 15 trains the first encoding model 151, the second encoding model 152, and the estimation model 153 in such a way that the estimation result of the estimation model 153 matches the correct answer data. That is, the machine learning processing unit 15 optimizes model parameters of the first encoding model 151, the second encoding model 152, and the estimation model 153 in such a way that the error between the estimation result of the estimation model 153 and the correct answer data decreases. For example, the machine learning processing unit 15 optimizes the model parameters of the first encoding model 151, the second encoding model 152, and the estimation model 153 in such a way that the error between the estimation result of the estimation model 153 and the correct answer data is minimized. This training improves the accuracy rate of the estimation result output from the estimation model 153.

The machine learning processing unit 15 trains the adversarial estimation model 154 in such a way that the estimated value of the second code by the adversarial estimation model 154 matches the second code. That is, the machine learning processing unit 15 optimizes model parameters of the adversarial estimation model 154 in such a way that an error between the estimated value of the second code by the adversarial estimation model 154 and an output value of the second code by the second encoding model 152 decreases. For example, the machine learning processing unit 15 optimizes the model parameters of the adversarial estimation model 154 in such a way that the error between the estimated value of the second code by the adversarial estimation model 154 and the output value of the second code by the second encoding model 152 is minimized. This training improves the accuracy rate of the estimated value of the second code output from the adversarial estimation model 154.

Further, the machine learning processing unit 15 trains the first encoding model 151 in such a way that the estimated value of the second code by the adversarial estimation model 154 does not match the second code. That is, the machine learning processing unit 15 optimizes the model parameters of the first encoding model in such a way that the error between the estimated value of the second code by the adversarial estimation model 154 and the output value of the second code by the second encoding model 152 increases. For example, the machine learning processing unit 15 optimizes the model parameters of the first encoding model in such a way that the error between the estimated value of the second code by the adversarial estimation model 154 and the output value of the second code by the second encoding model 152 is maximized. By this training, features overlapping with the second code are excluded from the first code output from the first encoding model 151.

In the present example embodiment, the adversarial estimation model 154 is trained in such a way as to improve the accuracy rate of the estimated value of the second code, and the first encoding model 151 is trained to reduce the overlap between the first code and the second code. That is, in the present example embodiment, the first encoding model 151 and the adversarial estimation model 154 are trained in an adversarial manner. As a result, common features that can be included in the first code output from the first encoding model 151 and the second code output from the second encoding model 152 are eliminated.

In the present example embodiment, an example of a configuration will be described in which the first encoding model 151 and the adversarial estimation model 154 are trained in an adversarial manner using the first code output from the first encoding model 151. In the present example embodiment, a configuration may be employed in which the second encoding model 152 and the adversarial estimation model 154 are trained in an adversarial manner using the second code output from the second encoding model 152. The method of the present example embodiment may be used to eliminate duplication that may be included in sensor data measured by three or more measuring devices.

For example, the machine learning processing unit 15 trains the first encoding model 151, the second encoding model 152, and the estimation model 153 in such a way that a sum of squares error or a cross entropy error between the output of the estimation model 153 and the correct answer data is minimized. For example, the machine learning processing unit 15 trains the first encoding model 151, the second encoding model 152, and the estimation model 153 in such a way that a loss function of the following Equation 1 is minimized.

$$\begin{matrix}[ Math . 1 ] & \\ {‖ L - F ( {G}_{x} ( x ) , {G}_{y} ( y ) ) ‖}^{2} + λ {‖ {G}_{y} ( y ) - {C}_{x} ( {G}_{x} ( x ) ) ‖}^{- 2} & ( 1 )\end{matrix}$$

In Equation 1 described above, L is the correct answer data. x is the first sensor data (first raw data) measured by the first measuring device 111. y is the second sensor data (second raw data) measured by the second measuring device 112. Gₓ(x) is the first encoding model 151. G_{y}(y) is the second encoding model 152. F(Gₓ(x), G_{y}(y)) is the estimation model 153. Cₓ(Gₓ(x)) is the adversarial estimation model 154. λ is a weight parameter (one-dimensional real value).

For example, the machine learning processing unit 15 trains the adversarial estimation model 154 in such a way that an error such as a sum of squares error or a cross entropy error between the output (second code) of the second encoding model 152 and the estimated value of the second code by the adversarial estimation model 154 is minimized. For example, the machine learning processing unit 15 trains the adversarial estimation model 154 in such a way that a loss function of the following Equation 2 is minimized.

$$\begin{matrix}[ Math . 2 ] & \\ {‖ {G}_{y} ( y ) - {C}_{x} ( {G}_{x} ( x ) ) ‖}^{2} & ( 2 )\end{matrix}$$

For example, the machine learning processing unit 15 trains the first encoding model 151 in such a way that an error such as a sum of squares error or a cross entropy error between the output (second code) of the second encoding model 152 and the estimated value of the second code by the adversarial estimation model 154 is maximized.

In the model group trained by the machine learning processing unit 15, the first encoding model 151, the second encoding model 152, and the estimation model 153 are implemented in an estimation system (not illustrated) that performs estimation based on raw data. For example, the estimation system includes a first measuring device that measures first measurement data (first raw data), a second measuring device that measures second measurement data (second raw data), and an estimation device (not illustrated) that performs estimation using the measurement data. The first encoding model 151 is implemented on the first measuring device. The second encoding model 152 is implemented on the second measuring device. The estimation model 153 is implemented in the estimation device. The first measuring device encodes the first measurement data into the first code using the first encoding model. The first measuring device transmits the encoded first code to the estimation device. The second measuring device encodes the second measurement data into the second code using the first encoding model. The second measuring device transmits the encoded second code to the estimation device. The estimation device inputs the first code received from the first measuring device and the second code received from the second measuring device to the estimation model. The estimation device outputs an estimation result output from the estimation model in response to the input of the first code and the second code. Details of the estimation system using the model trained by the machine learning processing unit 15 will be described later.

### Operation

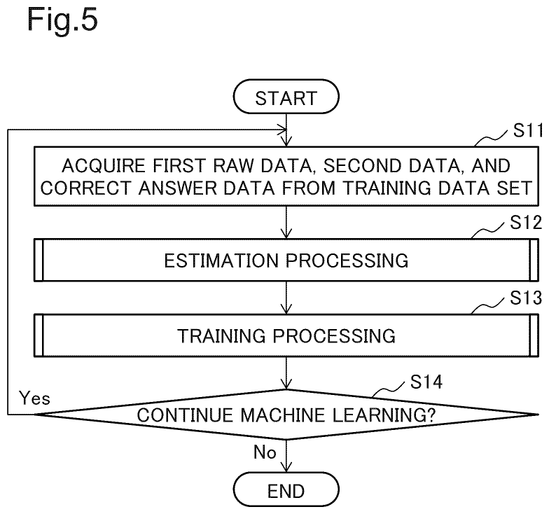

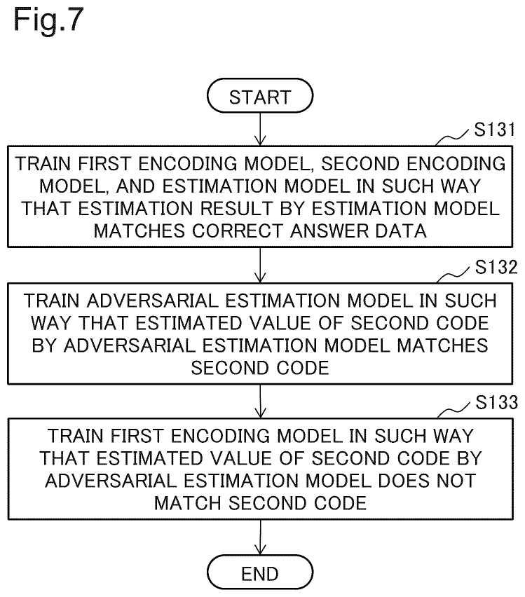

Next, operation of the machine learning device 10 of the present example embodiment will be described with reference to the drawings. FIGS. 5 to 7 are flowcharts for describing an example of the operation of the machine learning device 10. In the description along the flowchart of FIG. 5, the machine learning device 10 will be described as an operation subject.

In FIG. 5, first, the machine learning device 10 acquires first raw data, second raw data, and correct answer data from the training data set (step S11).

Next, the machine learning device 10 executes estimation processing using a model group of the first encoding model 151, the second encoding model 152, the estimation model 153, and the adversarial estimation model 154 (step S12). In the estimation processing, encoding into the first code by the first encoding model 151, encoding into the second code by the second encoding model 152, and estimation of the estimation result by the estimation model 153 are performed. In the estimation processing, the second code is estimated by the adversarial estimation model 154. Details of the estimation processing in step S12 will be described later.

Next, the machine learning device 10 executes training processing of the first encoding model 151, the second encoding model 152, the estimation model 153, and the adversarial estimation model 154 according to the estimation result of the model group (step S13). The model parameters of the model group trained by the machine learning processing unit 15 are set in the first encoding model 151, the second encoding model 152, and the estimation model 153 implemented in the estimation system (not illustrated). Details of the training processing in step S13 will be described later.

When the machine learning is continued (Yes in step S14), the processing returns to step S11. On the other hand, when the machine learning is stopped (No in step S14), the processing according to the flowchart of FIG. 5 is ended. The continuation/end of the machine learning is only required to be determined based on a preset criterion. For example, the machine learning device 10 determines to continue or end the machine learning according to the accuracy rate of the estimation result by the estimation model 153. For example, the machine learning device 10 determines to continue or end the machine learning according to the error between the estimated value of the second code by the adversarial estimation unit 14 and the second code output from the second encoding model 152.

### [Estimation Processing]

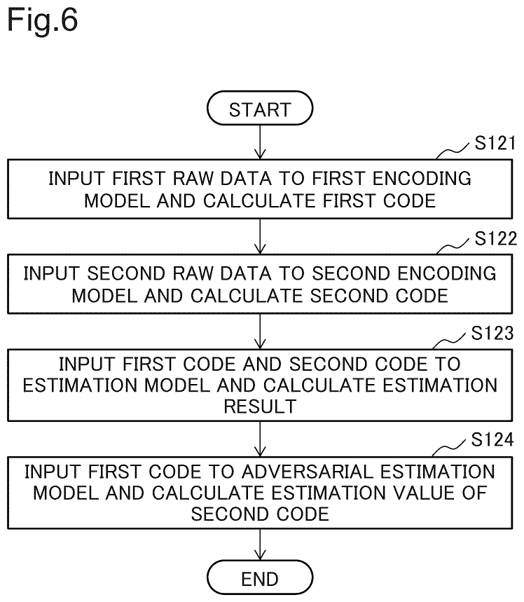

Next, estimation processing (step S12 in FIG. 5) by the machine learning processing unit 15 will be described with reference to the drawings. FIG. 6 is a flowchart for describing the estimation processing by the machine learning processing unit 15. In the processing along the flowchart of FIG. 6, the machine learning device 10 will be described as an operation subject.

In FIG. 6, first, the machine learning device 10 inputs the first raw data to the first encoding model 151 and calculates the first code (step S121). A code output from the first encoding model 151 in response to the input of the first raw data is the first code.

Next, the machine learning device 10 inputs the second raw data to the second encoding model 152 and calculates the second code (step S122). The code output from the second encoding model 152 in response to the input of the second raw data is the second code. The order of steps S121 and S122 may be changed, or the steps may be performed in parallel.

Next, the machine learning device 10 inputs the first code and the second code to the estimation model 153 and calculates an estimation result (step S123). The result output from the estimation model 153 in response to the input of the first raw data and the second raw data is the estimation result.

Next, the machine learning device 10 inputs the first code to the adversarial estimation model 154 and calculates an estimated value of the second code (step S124). The code output from the adversarial estimation model 154 in response to the input of the first code is the estimated value of the second code. The order of steps S123 and S124 may be changed, or the steps may be performed in parallel.

### [Training Processing]

Next, training processing (step S13 in FIG. 5) by the machine learning processing unit 15 will be described with reference to the drawings. FIG. 6 is a flowchart for describing training processing by the machine learning processing unit 15. In the processing along the flowchart of FIG. 6, the machine learning processing unit 15 will be described as an operation subject.

In FIG. 6, first, the machine learning processing unit 15 trains the first encoding model 151, the second encoding model 152, and the estimation model 153 in such a way that the estimation result by the estimation model 153 matches the correct answer data (step $131).

Next, the machine learning processing unit 15 trains the adversarial estimation model 154 in such a way that the estimated value of the second code by the adversarial estimation model 154 matches the second code output from the second encoding model 152 (step S132).

Next, the machine learning processing unit 15 trains the first encoding model 151 in such a way that the estimated value of the second code by the adversarial estimation model 154 does not match the second code output from the second encoding model 152 (step S133). The order of steps S132 and S133 may be changed, or the steps may be performed in parallel.

As described above, the machine learning device according to the present example embodiment includes the acquisition unit, the encoding unit, the estimation unit, the adversarial estimation unit, and the machine learning processing unit. The encoding unit includes an encoding model. The estimation unit includes an estimation model. The adversarial estimation unit includes an adversarial estimation model. The acquisition unit acquires a training data set including first sensor data measured by the first measuring device, second sensor data measured by the second measuring device, and correct answer data. The encoding unit encodes the first sensor data into a first code using the first encoding model, and encodes the second sensor data into a second code using the second encoding model. The estimation unit inputs the first code and the second code to the estimation model and outputs an estimation result output from the estimation model. The adversarial estimation unit inputs the first code to the first adversarial estimation model that outputs an estimated value of the second code in response to the input of the first code, and estimates the estimated value of the second code.

The machine learning processing unit trains the first encoding model, the second encoding model, the estimation model, and the first adversarial estimation model by machine learning. The machine learning processing unit trains the first encoding model, the second encoding model, and the estimation model in such a way that the estimation result of the estimation model matches the correct answer data. The machine learning processing unit trains the first adversarial estimation model in such a way that the estimated value of the second code by the first adversarial estimation model matches the second code output from the second encoding model. The machine learning processing unit trains the first encoding model in such a way that the estimated value of the second code by the first adversarial estimation model does not match the second code output from the second encoding model.

The machine learning device of the present example embodiment trains the first adversarial estimation model in such a way that the second code output from the first adversarial estimation model in response to the input of the first code and the second code output from the second encoding device in response to the input of the second sensor data match. This training improves the estimation accuracy of the second code by the first adversarial estimation model. The machine learning device of the present example embodiment trains the first encoding model in such a way that the second code output from the first adversarial estimation model in response to the input of the first code and the second code output from the second encoding device in response to the input of the second sensor data do not match. This training reduces the estimation accuracy of the second code by the first adversarial estimation model. That is, the machine learning device of the present example embodiment trains the first adversarial estimation model and the first encoding model in an adversarial manner, thereby eliminating common features that can be included in the first code output from the first encoding model and the second code output from the second encoding model. Thus, according to the machine learning device of the present example embodiment, it is possible to construct a model capable of eliminating redundancy of codes derived from sensor data measured by a plurality of measuring instruments and efficiently reducing dimensions of the sensor data.

In one aspect of the present example embodiment, the machine learning processing unit trains the first encoding model, the second encoding model, and the estimation model in such a way that an error between the estimation result of the estimation model and the correct answer data decreases. The machine learning processing unit trains the first adversarial estimation model in such a way that an error between the estimated value of the second code by the first adversarial estimation model and the second code output from the second encoding model decreases. The machine learning processing unit trains the first encoding model in such a way that an error between the estimated value of the second code by the first adversarial estimation model and the second code output from the second encoding model is maximized. According to the present aspect, it is possible to construct a model capable of efficiently reducing the dimensions of sensor data according to the error between the estimated value of the second code by the first adversarial estimation model and the second code output from the second encoding model.

### Second Example Embodiment

Next, a machine learning device according to a second example embodiment will be described with reference to the drawings. The machine learning device of the present example embodiment is different from that of the first example embodiment in that both the first encoding model and the second encoding model are trained in an adversarial manner. Hereinafter, the description regarding points similar to those of the first example embodiment will be omitted/simplified.

### Configuration

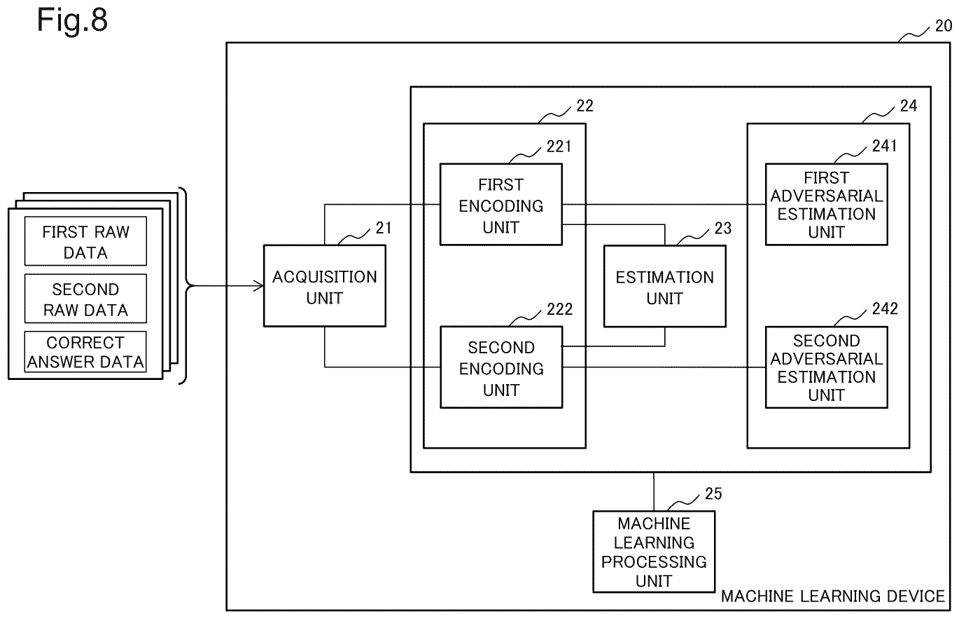

FIG. 8 is a block diagram illustrating an example of a configuration of the machine learning device 20 according to the present example embodiment. The machine learning device 20 includes an acquisition unit 21, an encoding unit 22, an estimation unit 23, an adversarial estimation unit 24, and a machine learning processing unit 25. The encoding unit 22 includes a first encoding unit 221 and a second encoding unit 222. The adversarial estimation unit 24 includes a first adversarial estimation unit 241 and a second adversarial estimation unit 242.

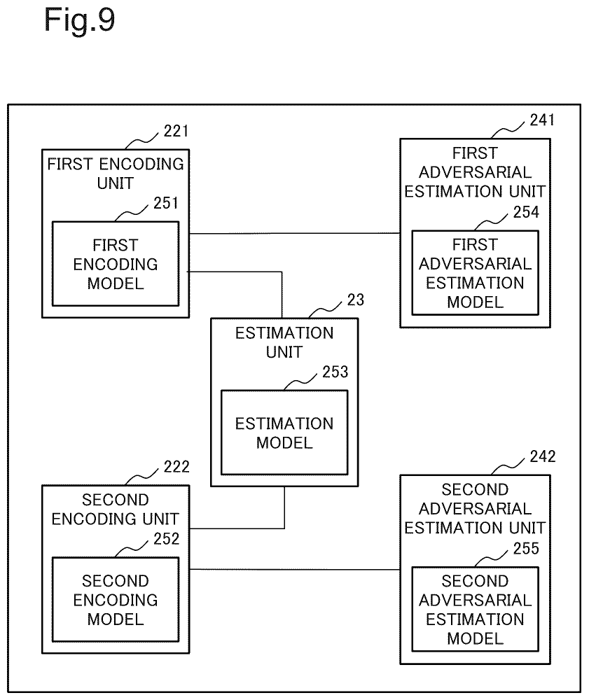

FIG. 9 is a block diagram for describing a model constructed by the machine learning device 20. In FIG. 9, the acquisition unit 21 and the machine learning processing unit 25 are omitted. The first encoding unit 221 includes a first encoding model 251. The second encoding unit 222 includes a second encoding model 252. The estimation unit 23 includes an estimation model 253. The first adversarial estimation unit 241 includes a first adversarial estimation model 254. The second adversarial estimation unit 242 includes a second adversarial estimation model 255. The first encoding model 251, the second encoding model 252, the estimation model 253, the first adversarial estimation model 254, and the second adversarial estimation model 255 are also collectively referred to as a model group. The second adversarial estimation unit 242 includes the second adversarial estimation model 255. Details of the first encoding model 251, the second encoding model 252, the estimation model 253, the first adversarial estimation model 254, and the second adversarial estimation model 255 will be described later.

The acquisition unit 21 has a configuration similar to that of the acquisition unit 11 of the first example embodiment. The acquisition unit 21 acquires a plurality of data sets (also referred to as training data sets) used for model construction. The training data set includes a data set combining first raw data, second raw data, and correct answer data.

The first raw data and the second raw data are sensor data measured by different measuring devices. The acquisition unit 21 acquires a training data set including the first raw data, the second raw data, and the correct answer data corresponding to each other from a plurality of training data sets included in the training data set.

The encoding unit 22 has a configuration similar to that of the encoding unit 12 of the first example embodiment. The encoding unit 22 acquires the first raw data and the second raw data from the acquisition unit 21. In the encoding unit 22, the first encoding unit 221 encodes the first raw data. The first raw data encoded by the first encoding unit 221 is a first code. The encoding unit 22 encodes the second raw data by the second encoding unit 222. The second raw data encoded by the second encoding unit 222 is a second code.

The first encoding unit 221 has a configuration similar to that of the first encoding unit 121 of the first example embodiment. The first encoding unit 221 acquires the first raw data. The first encoding unit 221 inputs the acquired first raw data to the first encoding model 251.

The first encoding model 251 has a configuration similar to that of the first encoding model 151 of the first example embodiment. The first encoding model 251 outputs the first code in response to the input of the first raw data. The first code includes features of the first raw data. That is, the first encoding unit 221 encodes the first raw data to generate the first code including the features of the first raw data.

The second encoding unit 222 has a configuration similar to that of the second encoding unit 122 of the first example embodiment. The second encoding unit 222 acquires the second raw data. The second encoding unit 222 inputs the acquired second raw data to the second encoding model 252. The second encoding model 252 has a configuration similar to that of the second encoding model 152 of the first example embodiment. The second encoding model 252 outputs the second code in response to the input of the second raw data. The second code includes features of the second raw data. That is, the second encoding unit 222 encodes the second raw data to generate the second code including the features of the second raw data.

The estimation unit 23 has a configuration similar to that of the estimation unit 13 of the first example embodiment. The estimation unit 23 acquires the first code and the second code from the encoding unit 22. The estimation unit 23 inputs the acquired first code and second code to the estimation model 253. The estimation model 253 has a configuration similar to that of the estimation model 153 of the first example embodiment. The estimation model 253 outputs an estimation result regarding the body condition of the subject in response to the input of the first code and the second code. That is, the estimation unit 23 estimates the body condition of the subject using the first code and the second code. The estimation unit 23 outputs the estimation result regarding the body condition of the subject. The estimation result by the estimation unit 23 is compared with the correct answer data of the body condition of the subject by the machine learning processing unit 25.

The adversarial estimation unit 24 acquires the first code and the second code from the encoding unit 22. The adversarial estimation unit 24 inputs the acquired first code to the first adversarial estimation model 254 of the first adversarial estimation unit 241. The adversarial estimation unit 24 inputs the acquired second code to the second adversarial estimation model 255 of the second adversarial estimation unit 242.

The first adversarial estimation model 254 outputs the second code in response to the input of the first code. That is, the first adversarial estimation model 254 estimates the second code using the first code. The estimated value of the second code by the first adversarial estimation unit 241 may include a common point with the first code. The estimated value of the second code by the first adversarial estimation unit 241 is compared with the second code encoded by the second encoding unit 222 by the machine learning processing unit 25.

The second adversarial estimation model 255 outputs the first code in response to the input of the second code. That is, the second adversarial estimation model 255 estimates the first code using the second code. The estimated value of the first code by the second adversarial estimation unit 242 may include a common point with the second code. The estimated value of the first code by the second adversarial estimation unit 242 is compared with the first code encoded by the first encoding unit 221 by the machine learning processing unit 25.

For example, the first encoding model 251, the second encoding model 252, the estimation model 253, the first adversarial estimation model 254, and the second adversarial estimation model 255 include a structure of deep neural network (DNN). For example, the first encoding model 251, the second encoding model 252, the estimation model 253, the first adversarial estimation model 254, and the second adversarial estimation model 255 include a structure of convolutional neural network (CNN). For example, the first encoding model 251, the second encoding model 252, the estimation model 253, the first adversarial estimation model 254, and the second adversarial estimation model 255 include a structure of recurrent neural network (RNN). Structures of the first encoding model 251, the second encoding model 252, the estimation model 253, the first adversarial estimation model 254, and the second adversarial estimation model 255 are not limited to DNN, CNN, and RNN. The first encoding model 251, the second encoding model 252, the estimation model 253, the first adversarial estimation model 254, and the second adversarial estimation model 255 are trained by machine learning by the machine learning processing unit 25.

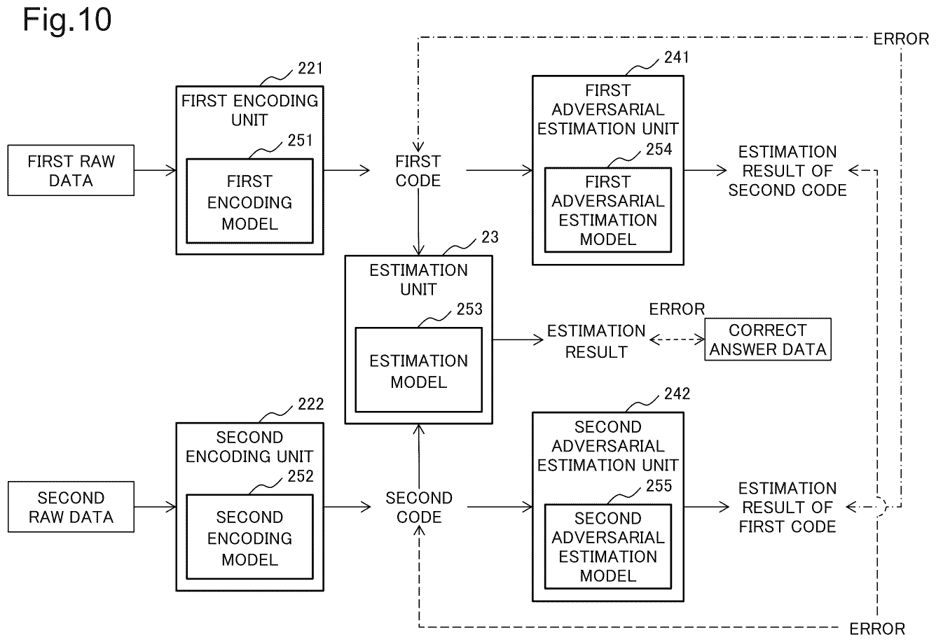

The machine learning processing unit 25 trains a model group of the first encoding model 251, the second encoding model 252, the estimation model 253, the first adversarial estimation model 254, and the second adversarial estimation model 255 by machine learning. FIG. 10 is a conceptual diagram for describing training of the first encoding model 251, the second encoding model 252, the estimation model 253, the first adversarial estimation model 254, and the second adversarial estimation model 255 by the machine learning processing unit 25. In FIG. 10, the acquisition unit 21 and the machine learning processing unit 25 are omitted.

The machine learning processing unit 25 trains the first encoding model 251, the second encoding model 252, and the estimation model 253 in such a way that the estimation result of the estimation model 253 matches the correct answer data. That is, the machine learning processing unit 25 optimizes the model parameters of the first encoding model 251, the second encoding model 252, and the estimation model 253 in such a way that the error between the estimation result of the estimation model 253 and the correct answer data is minimized. For example, the machine learning processing unit 25 trains the first encoding model 251, the second encoding model 252, and the estimation model 253 in such a way that an error such as a sum of squares error or a cross entropy error between the output of the estimation model 253 and the correct answer data is minimized. Such training improves the accuracy rate of the estimation result output from the estimation model 253.

For example, the machine learning processing unit 25 trains the first encoding model 251, the second encoding model 252, and the estimation model 253 in such a way that a sum of squares error or a cross entropy error between the output of the estimation model 253 and the correct answer data is minimized. For example, the machine learning processing unit 25 trains the first encoding model 251, the second encoding model 252, and the estimation model 253 in such a way that a loss function of the following Equation 3 is minimized.

$$\begin{matrix}[ Math . 3 ] & \\ {‖ L - F ( {G}_{x} ( x ) , {G}_{y} ( y ) ) ‖}^{2} + λ {‖ {G}_{y} ( y ) - {C}_{x} ( {G}_{x} ( x ) ) ‖}^{- 2} + λ {‖ {G}_{x} ( x ) - {C}_{y} ( {G}_{y} ( y ) ) ‖}^{- 2} & ( 3 )\end{matrix}$$

In Equation 3, L is the correct answer data. x is the first sensor data (first raw data) measured by the first measuring device (not illustrated). y is the second sensor data (second raw data) measured by the second measuring device (not illustrated). Gₓ(x) is the first encoding model 251. G_{y}(y) is the second encoding model 252. F(Gₓ(x), G_{y}(y)) is the estimation model 253. Cₓ(Gₓ(x)) is the first adversarial estimation model 254. C_{y}(G_{y}(y)) is the second adversarial estimation model 255. λ is a weight parameter (one-dimensional real value).

The machine learning processing unit 25 trains the first adversarial estimation model 254 in such a way that the estimated value of the second code by the first adversarial estimation model 254 matches the second code output from the second encoding model 252. That is, the machine learning processing unit 25 optimizes the model parameters of the first adversarial estimation model 254 in such a way that an error between the estimated value of the second code by the first adversarial estimation model 254 and the output value of the second code by the second encoding model 252 decreases. For example, the machine learning processing unit 25 trains the first adversarial estimation model 254 in such a way that an error such as a sum of squares error or a cross entropy error between the output (second code) of the second encoding model 252 and the estimated value of the second code by the first adversarial estimation model 254 is minimized. Such training improves the accuracy rate of the estimated value of the second code output from the first adversarial estimation model 254.

The machine learning processing unit 25 trains the second adversarial estimation model 255 in such a way that the estimated value of the first code by the second adversarial estimation model 255 matches the first code output from the first encoding model 251. That is, the machine learning processing unit 25 optimizes the model parameters of the second adversarial estimation model 255 in such a way that an error between the estimated value of the first code by the second adversarial estimation model 255 and the output value of the first code by the first encoding model 251 decreases. For example, the machine learning processing unit 25 trains the second adversarial estimation model 255 in such a way that an error such as a sum of squares error or a cross entropy error between the output (first code) of the first encoding model 251 and the estimated value of the first code by the second adversarial estimation model 255 is minimized. Such training improves the accuracy rate of the estimated value of the first code output from the second adversarial estimation model 255.

For example, the machine learning processing unit 25 trains the first adversarial estimation model 254 and the second adversarial estimation model 255 in such a way that a loss function of the following Equation 4 is minimized.

$$\begin{matrix}[ Math . 4 ] & \\ {‖ {G}_{y} ( y ) - {C}_{x} ( {G}_{x} ( x ) ) ‖}^{2} + {‖ {G}_{x} ( ) - {C}_{y} ( {G}_{y} ( y ) ) ‖}^{2} & ( 4 )\end{matrix}$$

Each parameter of the above Equation 4 is similar to that of the above Equation 3.

The machine learning processing unit 25 trains the first encoding model 251 in such a way that the estimated value of the second code by the first adversarial estimation model 254 does not match the second code. That is, the machine learning processing unit 25 optimizes the model parameters of the first encoding model 251 in such a way that the error between the estimated value of the second code by the first adversarial estimation model 254 and the output value of the second code by the second encoding model 252 increases. For example, the machine learning processing unit 25 trains the first encoding model 251 in such a way that an error such as a sum of squares error or a cross entropy error between the output (second code) of the second encoding model 252 and the estimated value of the second code by the first adversarial estimation model 254 is maximized. By this training, features overlapping with the second code are excluded from the first code output from the first encoding model 251.

The machine learning processing unit 25 trains the second encoding model 252 in such a way that the estimated value of the first code by the second adversarial estimation model 255 does not match the first code. That is, the machine learning processing unit 25 optimizes the model parameters of the second encoding model 252 in such a way that the error between the estimated value of the first code by the second adversarial estimation model 255 and the output value of the first code by the first encoding model 251 increases. For example, the machine learning processing unit 25 trains the second encoding model 252 in such a way that an error such as a sum of squares error or a cross entropy error between the output (first code) of the first encoding model 251 and the estimated value of the first code by the second adversarial estimation model 255 is maximized. By this training, features overlapping with the first code are excluded from the second code output from the second encoding model 252.

In the present example embodiment, the first adversarial estimation model 254 is trained in such a way as to improve the accuracy rate of the estimated value of the second code, and the first encoding model 251 is trained in such a way as to reduce the overlap between the first code and the second code. In the present example embodiment, the second adversarial estimation model 255 is trained in such a way as to improve the accuracy rate of the estimated value of the first code, and the second encoding model 252 is trained in such a way as to reduce overlap between the first code and the second code. As described above, in the present example embodiment, the first encoding model 251 and the first adversarial estimation model 254 are trained in an adversarial manner, and the second encoding model 252 and the second adversarial estimation model 255 are trained in an adversarial manner. As a result, common features that can be included in the first code output from the first encoding model 251 and the second code output from the second encoding model 252 are eliminated.

In the present example embodiment, an example of eliminating duplication that can be included in sensor data measured by two measuring devices will be described. The method of the present example embodiment may be used to eliminate duplication that may be included in sensor data measured by three or more measuring devices.

In the model group trained by the machine learning processing unit 25, the first encoding model 251, the second encoding model 252, and the estimation model 253 are implemented in an estimation system (not illustrated) that performs estimation based on raw data. For example, the estimation system includes a first measuring device that measures first measurement data (first raw data), a second measuring device that measures second measurement data (second raw data), and an estimation device (not illustrated) that performs estimation using the measurement data. The first encoding model 251 is implemented on the first measuring device. The second encoding model 252 is implemented on the second measuring device. The estimation model 253 is implemented in the estimation device. The first measuring device encodes the first measurement data into the first code using the first encoding model. The first measuring device transmits the encoded first code to the estimation device. The second measuring device encodes the second measurement data into the second code using the first encoding model. The second measuring device transmits the encoded second code to the estimation device. The estimation device inputs the first code received from the first measuring device and the second code received from the second measuring device to the estimation model. The estimation device outputs an estimation result output from the estimation model in response to the input of the first code and the second code. Details of the estimation system using the model trained by the machine learning processing unit 25 will be described later.

### Operation

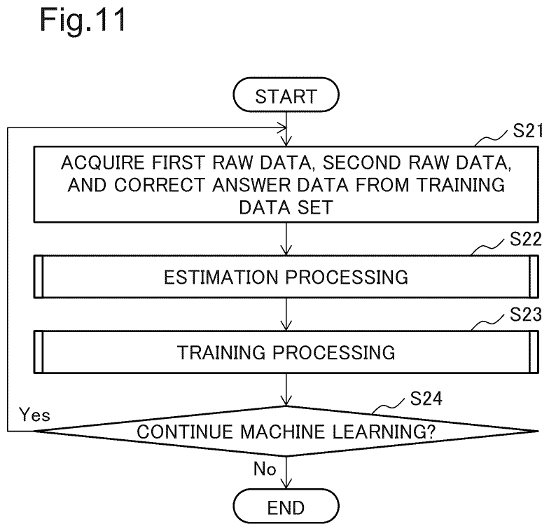

Next, operation of the machine learning device 20 of the present example embodiment will be described with reference to the drawings. FIGS. 11 to 13 are flowcharts for describing an example of the operation of the machine learning device 20. In the description along the flowchart of FIG. 11, the machine learning device 10 will be described as an operation subject.

In FIG. 11, first, the machine learning device 20 acquires first raw data, second raw data, and correct answer data from the training data set (step S21).

Next, the machine learning device 20 executes estimation processing using a model group of the first encoding model 251, the second encoding model 252, the estimation model 253, the first adversarial estimation model 254, and the second adversarial estimation model 255 (step S22). In the estimation processing, encoding into the first code by the first encoding model 251, encoding into the second code by the second encoding model 252, and estimation of the estimation result by the estimation model 253 are performed. In the estimation processing, estimation of the second code by the first adversarial estimation model 254 and estimation of the first code by the second adversarial estimation model 255 are performed. Details of the estimation processing in step S22 will be described later.

Next, the machine learning device 20 executes training processing of the first encoding model 251, the second encoding model 252, the estimation model 253, the first adversarial estimation model 254, and the second adversarial estimation model 255 according to the estimation result of the model group (step S23). The model parameters of the model group trained by the machine learning processing unit 25 are set in the first encoding model 251, the second encoding model 252, and the estimation model 253 implemented in an estimation system (not illustrated). Details of the training processing in step S23 will be described later.

When the machine learning is continued (Yes in step S24), the processing returns to step S21. On the other hand, when the machine learning is stopped (No in step S24), the processing according to the flowchart of FIG. 11 is ended. The continuation/end of the machine learning is only required to be determined based on a preset criterion. For example, the machine learning device 20 determines to continue or end the machine learning according to the accuracy rate of the estimation result by the estimation model 253. For example, the machine learning device 20 determines to continue or end the machine learning according to an error between the estimated value of the second code by the first adversarial estimation unit 241 and the second code output from the second encoding model 252. For example, the machine learning device 20 determines to continue or end the machine learning according to an error between the estimated value of the second code by the second adversarial estimation unit 242 and the first code output from the first encoding model 251.

### [Estimation Processing]

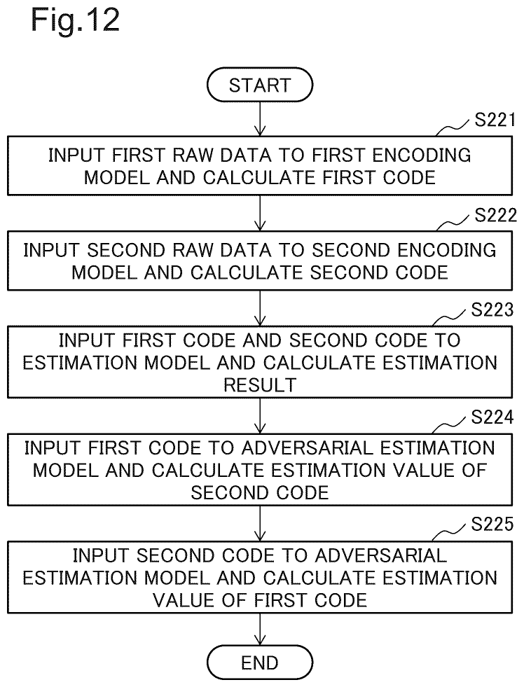

Next, estimation processing (step S22 in FIG. 11) by the machine learning processing unit 25 will be described with reference to the drawings. FIG. 12 is a flowchart for describing estimation processing by the machine learning processing unit 25. In the processing along the flowchart of FIG. 12, the machine learning device 20 will be described as an operation subject.

In FIG. 12, first, the machine learning device 20 inputs the first raw data to the first encoding model 251 and calculates the first code (step S221). A code output from the first encoding model 251 in response to the input of the first raw data is the first code.

Next, the machine learning device 20 inputs the second raw data to the second encoding model 252 and calculates the second code (step S222). A code output from the second encoding model 252 in response to the input of the second raw data is the second code. The order of steps S221 and S222 may be changed, or the steps may be performed in parallel.

Next, the machine learning device 20 inputs the first code and the second code to the estimation model 253 and calculates an estimation result (step S223). The result output from the estimation model 253 in response to the input of the first raw data and the second raw data is the estimation result.

Next, the machine learning device 20 inputs the first code to the first adversarial estimation model 254 and calculates an estimated value of the second code (step S224). The code output from the first adversarial estimation model 254 in response to the input of the first code is the estimated value of the second code.

Next, the machine learning device 20 inputs the second code to the second adversarial estimation model 255 and calculates an estimated value of the first code (step S225). The code output from the second adversarial estimation model 255 in response to the input of the second code is the estimated value of the first code. The order of steps S223 to S225 may be changed, or the steps may be performed in parallel.

### [Training Processing]

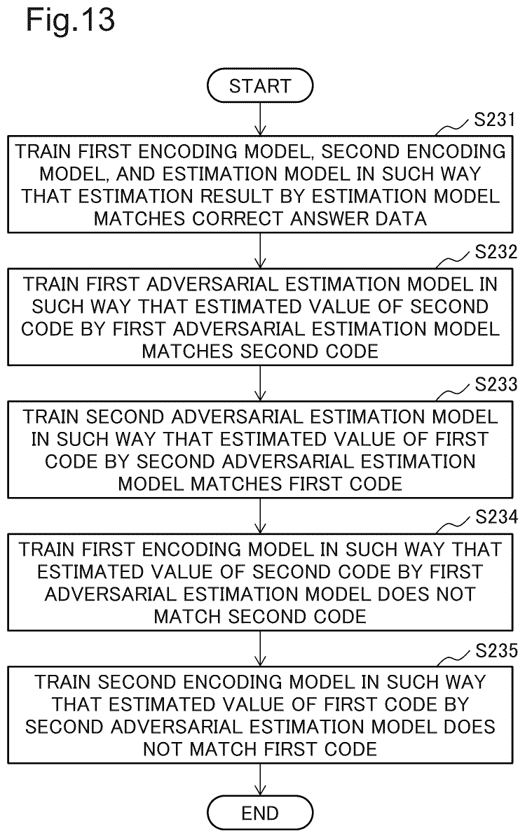

Next, training processing (step S23 in FIG. 11) by the machine learning processing unit 25 will be described with reference to the drawings. FIG. 13 is a flowchart for describing training processing by the machine learning processing unit 25. In the processing along the flowchart of FIG. 13, the machine learning processing unit 25 will be described as an operation subject.

In FIG. 13, first, the machine learning processing unit 25 trains the first encoding model 251, the second encoding model 252, and the estimation model 253 in such a way that the estimation result by the estimation model 253 matches the correct answer data (step S231).

Next, the machine learning processing unit 25 trains the first adversarial estimation model 254 in such a way that the estimated value of the second code by the first adversarial estimation model 254 matches the second code output from the second encoding model 252 (step S232).

Next, the machine learning processing unit 25 trains the second adversarial estimation model 255 in such a way that the estimated value of the first code by the second adversarial estimation model 255 matches the first code output from the first encoding model 251 (step S233). The order of steps S232 and S233 may be changed, or the steps may be performed in parallel.

Next, the machine learning processing unit 25 trains the first encoding model 251 in such a way that the estimated value of the second code by the first adversarial estimation model 254 does not match the second code output from the second encoding model 252 (step S234).

Next, the machine learning processing unit 25 trains the second encoding model 252 in such a way that the estimated value of the first code by the second adversarial estimation model 255 does not match the first code output from the first encoding model 251 (step S235). The order of steps S234 and S235 may be changed, or the steps may be performed in parallel.

As described above, the machine learning device according to the present example embodiment includes the acquisition unit, the encoding unit, the estimation unit, the adversarial estimation unit, and the machine learning processing unit. The encoding unit includes a first encoding model and a second encoding model. The estimation unit includes an estimation model. The adversarial estimation unit includes a first adversarial estimation model and a second adversarial estimation model. The acquisition unit acquires a training data set including first sensor data measured by the first measuring device, second sensor data measured by the second measuring device, and correct answer data. The encoding unit encodes the first sensor data into a first code using the first encoding model, and encodes the second sensor data into a second code using the second encoding model. The estimation unit inputs the first code and the second code to the estimation model and outputs an estimation result output from the estimation model. The adversarial estimation unit inputs the first code to the first adversarial estimation model that outputs an estimated value of the second code in response to the input of the first code, and estimates the estimated value of the second code. The adversarial estimation unit inputs the second code to the second adversarial estimation model that outputs an estimated value of the first code in response to the input of the second code, and estimates the estimated value of the first code.

The machine learning processing unit trains the first encoding model, the second encoding model, the estimation model, the first adversarial estimation model, and the second adversarial encoding model by machine learning. The machine learning processing unit trains the first encoding model, the second encoding model, and the estimation model in such a way that the estimation result of the estimation model matches the correct answer data. The machine learning processing unit trains the first adversarial estimation model in such a way that the estimated value of the second code by the first adversarial estimation model matches the second code output from the second encoding model. The machine learning processing unit trains the second adversarial estimation model in such a way that the estimated value of the first code by the second adversarial estimation model matches the first code output from the first encoding model. The machine learning processing unit trains the first encoding model in such a way that the estimated value of the second code by the first adversarial estimation model does not match the second code output from the second encoding model. The machine learning processing unit trains the second encoding model in such a way that the estimated value of the first code by the second adversarial estimation model does not match the first code output from the first encoding model.

The machine learning device of the present example embodiment trains the first adversarial estimation model in such a way that the second code output from the first adversarial estimation model in response to the input of the first code and the second code output from the second encoding device in response to the input of the second sensor data match. The machine learning device of the present example embodiment trains the second adversarial estimation model in such a way that the first code output from the second adversarial estimation model in response to the input of the second code and the first code output from the first encoding device in response to the input of the first sensor data match. By these training, the estimation accuracy of the second code by the first adversarial estimation model and the estimation accuracy of the first code by the second adversarial estimation model are improved.

The machine learning device of the present example embodiment trains the first encoding model in such a way that the second code output from the first adversarial estimation model in response to the input of the first code and the second code output from the second encoding device in response to the input of the second sensor data do not match. The machine learning device of the present example embodiment trains the second encoding model in such a way that the first code output from the second adversarial estimation model in response to the input of the second code and the first code output from the first encoding device in response to the input of the first sensor data do not match. By these training, the estimation accuracy of the second code by the first adversarial estimation model and the estimation accuracy of the first code by the second adversarial estimation model decrease. That is, the machine learning device of the present example embodiment trains the first adversarial estimation model and the first encoding model in an adversarial manner, and trains the second adversarial estimation model and the second encoding model in an adversarial manner. As a result, common features that can be included in the first code output from the first encoding model and the second code output from the second encoding model are eliminated. Thus, according to the machine learning device of the present example embodiment, it is possible to construct a model capable of eliminating redundancy of codes derived from sensor data measured by a plurality of measuring instruments and efficiently reducing dimensions of the sensor data.

In one aspect of the present example embodiment, the machine learning processing unit trains the second adversarial estimation model in such a way that an error between the estimated value of the first code by the second adversarial estimation model and the first code output from the first encoding model decreases. The machine learning processing unit trains the second encoding model in such a way that the error between the estimated value of the first code by the second adversarial estimation model and the first code output from the first encoding model increases. According to the present aspect, it is possible to construct a model capable of efficiently reducing the dimensions of sensor data according to the error between the estimated value of the first code by the second adversarial estimation model and the first code output from the first encoding model.

The adversarial estimation of the present example embodiment may be applied to three or more measuring devices. For example, in a case where there are three measuring devices, adversarial estimation is performed among all the measuring devices. By performing the adversarial estimation in this manner, the duplication of the codes related to the measured sensor data is eliminated for all the measuring devices. For example, in a case where there are three measuring devices, at least one pair of two measuring devices may be selected from the three measuring devices, and the adversarial estimation may be performed on the pair of measuring devices. By performing the adversarial estimation in this manner, duplication of codes related to sensor data to be measured is eliminated between the measuring devices on which the adversarial estimation has been performed.

### Third Example Embodiment

Next, a machine learning device according to a third example embodiment will be described with reference to the drawings. The machine learning device of the present example embodiment has a configuration in which the machine learning devices of the first and second example embodiments are simplified.

### Configuration

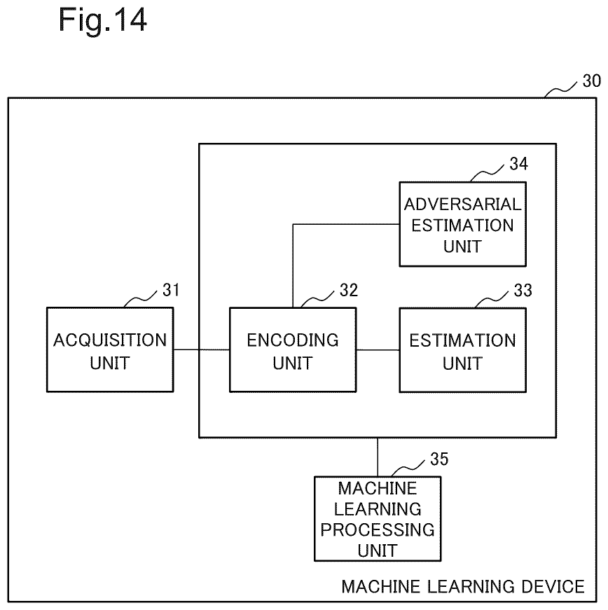

FIG. 14 is a block diagram illustrating an example of a configuration of the machine learning device 30 according to the present The machine learning device 30 includes an example embodiment. acquisition unit 31, an encoding unit 32, an estimation unit 33, an adversarial estimation unit 34, and a machine learning processing unit 35. The encoding unit 32 includes an encoding model. The estimation unit 33 includes an estimation model. The adversarial estimation unit 34 includes an adversarial estimation model.

The acquisition unit 31 acquires a training data set including first sensor data measured by the first measuring device, second sensor data measured by the second measuring device, and correct answer data. The encoding unit 32 encodes the first sensor data into a first code using the first encoding model, and encodes the second sensor data into a second code using the second encoding model. The estimation unit 33 inputs the first code and the second code to the estimation model and outputs an estimation result output from the estimation model. The adversarial estimation unit 34 inputs the first code to the first adversarial estimation model that outputs an estimated value of the second code in response to the input of the first code, and estimates the estimated value of the second code. The machine learning processing unit 35 trains the first encoding model, the second encoding model, the estimation model, and the first adversarial estimation model by machine learning. The machine learning processing unit 35 trains the first encoding model, the second encoding model, and the estimation model in such a way that the estimation result of the estimation model matches the correct answer data. The machine learning processing unit 35 trains the first adversarial estimation model in such a way that the estimated value of the second code by the first adversarial estimation model matches the second code output from the second encoding model. The machine learning processing unit 35 trains the first encoding model in such a way that the estimated value of the second code by the first adversarial estimation model does not match the second code output from the second encoding model.

The machine learning device of the present example embodiment trains the first adversarial estimation model and the first encoding model in an adversarial manner, thereby eliminating common features that can be included in the first code output from the first encoding model and the second code output from the second encoding model. Thus, according to the machine learning device of the present example embodiment, it is possible to construct a model capable of eliminating redundancy of codes derived from sensor data measured by a plurality of measuring instruments and efficiently reducing dimensions of the sensor data.

### Fourth Example Embodiment

Next, an estimation system according to a fourth example embodiment will be described with reference to the drawings. The estimation system of the present example embodiment includes an estimation device including a first encoding model, a second encoding model, and an estimation model constructed by the machine learning devices of the first to third example embodiments. The estimation system of the present example embodiment includes a first measuring device installed on footwear worn by a user. The first measuring device measures a physical quantity (first sensor data) related to the movement of the foot. The estimation system of the present example embodiment includes a second measuring device worn on the wrist of the user. The second measuring device measures a physical quantity and biological data (second sensor data) related to a physical activity. The estimation system of the present example embodiment performs estimation regarding the body condition of the user based on the measured first sensor data and second sensor data.

The first measuring device and the second measuring device may be worn on a body part other than the foot portion or the wrist. For example, the first measuring device may be worn on the foot portion of the left foot, and the second measuring device may be worn on the foot portion of the right foot. For example, the first measuring device may be worn on the wrist of the left hand, and the second measuring device may be worn on the wrist of the right hand. For example, the first measuring device and the second measuring device may be worn on the same body part. As long as an appropriate physical quantity/biological data can be measured according to the physical activity of the user, attachment places of the first measuring device and the second measuring device are not limited.

### Configuration

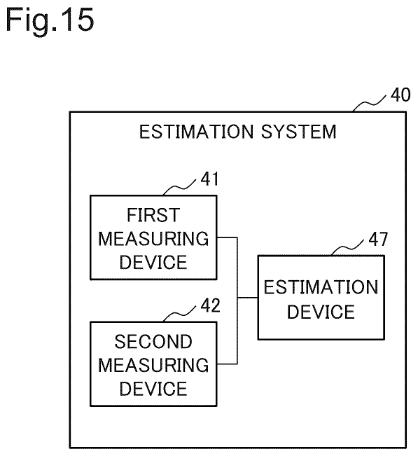

FIG. 15 is a block diagram illustrating an example of a configuration of the estimation system 40 according to the present example embodiment. The estimation system 40 includes a first measuring device 41, a second measuring device 42, and an estimation device 47. The first measuring device 41 and the estimation device 47 may be connected by wire or wirelessly. Similarly, the second measuring device 42 and the estimation device 47 may be connected by wire or wirelessly.

### [First Measuring Device]

The first measuring device 41 is installed on the foot portion. For example, the first measuring device 41 is installed on footwear such as a shoe. In the present example embodiment, an example in which the first measuring device 41 is arranged at a position on the back side of the arch of foot will be described.

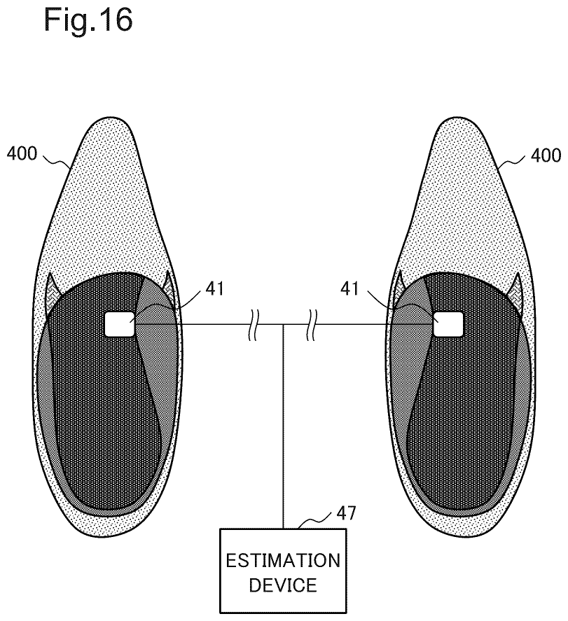

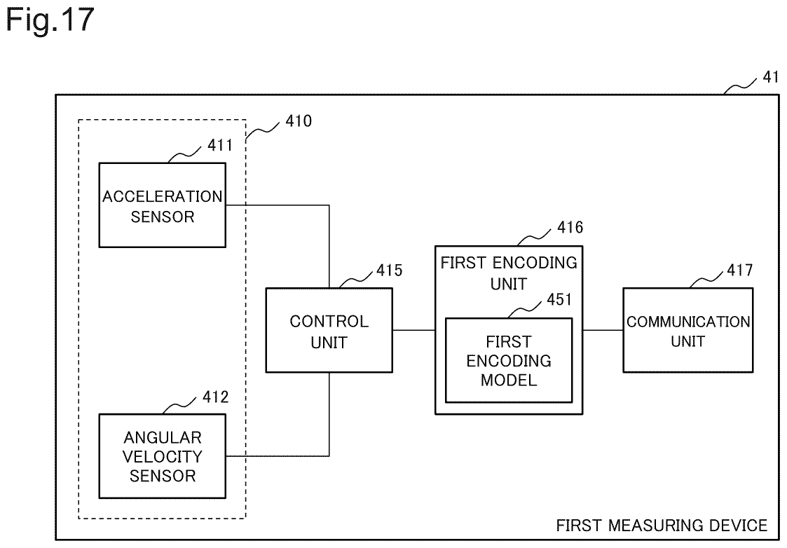

FIG. 16 is a conceptual diagram illustrating an example in which first measuring device 41 is arranged in footwear 400. In the example of FIG. 16, the first measuring device 41 is installed at a position corresponding to the back side of the arch of foot. For example, the first measuring device 41 is arranged in an insole inserted into the footwear 400. For example, the first measuring device 41 is arranged on a bottom surface of the footwear 400. For example, the first measuring device 41 is embedded in a main body of the footwear 400. The first measuring device 41 may be detachable from the footwear 400 or may not be detachable from the footwear 400. The first measuring device 41 may be installed at a position other than the back side of the arch of foot as long as sensor data regarding the movement of the foot can be acquired. The first measuring device 41 may be installed on a sock worn by the user or a decorative article such as an anklet worn by the user. The first measuring device 41 may be directly attached to the foot or may be embedded in the foot. FIG. 17 illustrates an example in which the first measuring device 41 is installed on the footwear 400 of both right and left feet, but the first measuring device 41 may be installed on the footwear 400 of one foot.

FIG. 17 is a block diagram illustrating an example of a detailed configuration of the first measuring device 41. The first measuring device 41 includes a sensor 410, a control unit 415, a first encoding unit 416, and a transmission unit 417. The sensor 410 includes an acceleration sensor 411 and an angular velocity sensor 412. The sensor 410 may include a sensor other than the acceleration sensor 411 and the angular velocity sensor 412. The first encoding unit 416 includes a first encoding model 451. The first measuring device 41 includes a real-time clock and a power supply (not illustrated).

The acceleration sensor 411 is a sensor that measures accelerations (also referred to as spatial accelerations) in three axial directions. The acceleration sensor 411 outputs the measured acceleration to the control unit 415. For example, a sensor of a piezoelectric type, a piezoresistive type, a capacitance type, or the like can be used as the acceleration sensor 411. The measurement method of the sensor used for the acceleration sensor 411 is not limited as long as the sensor can measure acceleration.

The angular velocity sensor 412 is a sensor that measures angular velocities in three axial directions (also referred to as spatial angular velocities). The angular velocity sensor 412 outputs the measured angular velocity to the control unit 415. For example, a sensor of a vibration type, a capacitance type, or the like can be used as the angular velocity sensor 412. The measurement method of the sensor used for the angular velocity sensor 412 is not limited as long as the sensor can measure the angular velocity.

The first measuring device 41 includes, for example, an inertial measuring device including an acceleration sensor 411 and an angular velocity sensor 412. An example of the inertial measuring device is an inertial measurement unit (IMU). The IMU includes an acceleration sensor that measures accelerations in three-axis directions and an angular velocity sensor that measures angular velocities around the three axes. The first measuring device 41 may be implemented by an inertial measuring device such as a vertical gyro (VG) or an attitude heading (AHRS). The first measuring device 41 may be implemented by global positioning system/inertial navigation system (GPS/INS).

The control unit 415 acquires the acceleration in the three-axis direction and the angular velocity around the three axes from each of the acceleration sensor 411 and the angular velocity sensor 412. The control unit 415 converts the acquired acceleration and angular velocity into digital data, and outputs the converted digital data (also referred to as first sensor data) to the first encoding unit 416. The first sensor data includes at least acceleration data converted into digital data and angular velocity data converted into digital data. The acceleration data includes acceleration vectors in three axial directions. The angular velocity data includes angular velocity vectors around three axes. The first sensor data is associated with an acquisition time of the data. The control unit 415 may be configured to output first sensor data obtained by adding correction such as a mounting error, temperature correction, and linearity correction to the acquired acceleration data and angular velocity data. The control unit 415 may generate angle data around three axes using the acquired acceleration data and angular velocity data.

For example, the control unit 415 is a microcomputer or a microcontroller that performs overall control and data processing of the first measuring device 41. For example, the control unit 415 includes a central processing unit (CPU), a random access memory (RAM), a read only memory (ROM), a flash memory, and the like. The control unit 415 controls the acceleration sensor 411 and the angular velocity sensor 412 to measure the angular velocity and the acceleration. For example, the control unit 415 performs analog-to-digital conversion (AD conversion) on physical quantities (analog data) such as the measured angular velocity and acceleration, and causes the converted digital data to be stored in the flash memory. The physical quantity (analog data) measured by the acceleration sensor 411 and the angular velocity sensor 412 may be converted into digital data in each of the acceleration sensor 411 and the angular velocity sensor 412. The digital data stored in the flash memory is output to the first encoding unit 416 at a predetermined timing.

The first encoding unit 416 acquires the first sensor data from the control unit 415. The first encoding unit 416 includes the first encoding model 451. The first encoding model 451 is a first encoding model constructed by the machine learning devices of the first to third example embodiments. For example, model parameters set by the machine learning device of the first or third example embodiment are set in the first encoding model 451. The first encoding unit 416 inputs the acquired first sensor data to the first encoding model 451 and encodes the first sensor data into a first code. The first encoding unit 416 outputs the encoded first code to the transmission unit 417.

The transmission unit 417 acquires the first code from first encoding unit 416. The transmission unit 417 transmits the acquired first code to the estimation device 47. The transmission unit 417 may transmit the first code to the estimation device 47 via a wire such as a cable, or may transmit the first code to the estimation device 47 via wireless communication. For example, the transmission unit 417 is configured to transmit the first code to the estimation device 47 via a wireless communication function (not illustrated) conforming to a standard such as Bluetooth (registered trademark) or WiFi (registered trademark). The communication function of the transmission unit 417 may conform to a standard other than Bluetooth (registered trademark) or

WiFi (registered trademark). The transmission unit 417 also has a function of receiving data transmitted from the estimation device 47. For example, the transmission unit 417 receives update data of model parameters, universal time data, and the like from the estimation device 47. The transmission unit 417 outputs the received data to the control unit 415.

For example, the first measuring device 41 is connected to the estimation device 47 via a mobile terminal (not illustrated) carried by the user. When the communication between the first measuring device 41 and the mobile terminal is successful and the first code is transmitted from the first measuring device 41 to the mobile terminal, the measurement in the measurement time zone is ended. For example, when communication between the first measuring device 41 and the mobile terminal is successful, the clock time of the first measuring device 41 may be synchronized with the clock time of the mobile terminal. When communication between the first measuring device 41 and the mobile terminal fails and the first code is not transmitted from the first measuring device 41 to the mobile terminal, the first code in the measurement time zone only needs to be retransmitted in the next or subsequent measurement time zone. For example, when the communication between the first measuring device 41 and the mobile terminal fails, the transmission of the first code in the measurement time zone may be repeated until the communication succeeds. For example, when the communication between the first measuring device 41 and the mobile terminal fails, the transmission of the first code in the measurement time zone may be repeated within a predetermined time. The first code of the measurement time zone in which the transmission has failed only needs to be stored in a storage device (not illustrated) such as an electrically erasable programmable read-only memory (EEPROM) until the next transmission timing.

In a case where the first measuring devices 41 are mounted on both the right and left feet, the clock time of first measuring devices 41 is synchronized with the clock time of the mobile terminal, so that the clock time of first measuring devices 41 mounted on both the feet can be synchronized. The first measuring devices 41 mounted on both feet may perform measurement at the same timing or may perform measurement at different timings. For example, in a case where the measurement timing by the first measuring device 41 mounted on both feet is greatly deviated based on the measurement time of both feet and the number of measurement failures, correction may be performed to reduce the deviation of the measurement timing. The correction of the measurement timing only needs to be performed in the estimation device 47 that can process the first code transmitted from the first measuring device 41 installed on both feet or in a higher system.

### [Second Measuring Device]

The second measuring device 42 is installed on the wrist. The second measuring device 42 collects information related to the physical activity of the user. For example, the second measuring device 42 is a wristwatch-type wearable device worn on a wrist. For example, the second measuring device 42 is achieved by an activity meter. For example, the second measuring device 42 is achieved by a smart watch. For example, the second measuring device 42 may include a global positioning system (GPS).

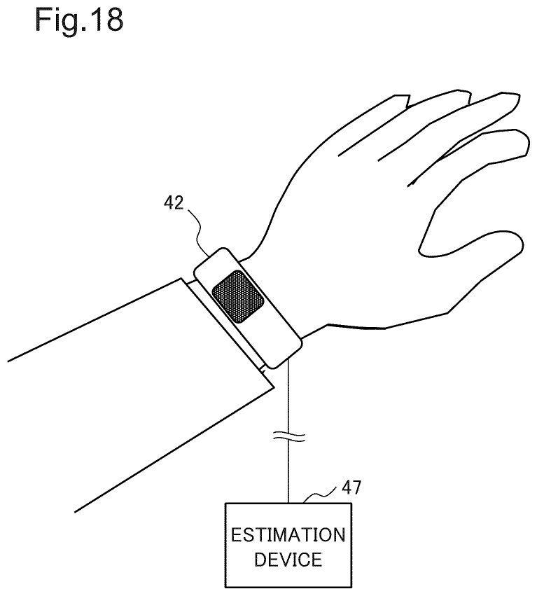

FIG. 18 is a conceptual diagram illustrating an example in which the second measuring device 42 is arranged on the wrist. The second measuring device 42 may be worn on a site other than the wrist as long as it can collect information related to the physical activity of the user. For example, the second measuring device 42 may be worn on a head, a neck, a chest, a back, a waist, an abdomen, a thigh, a lower leg, an ankle, or the like. The wearing portion of the second measuring device 42 is not particularly limited. The second measuring device 42 may be worn on a plurality of body parts.

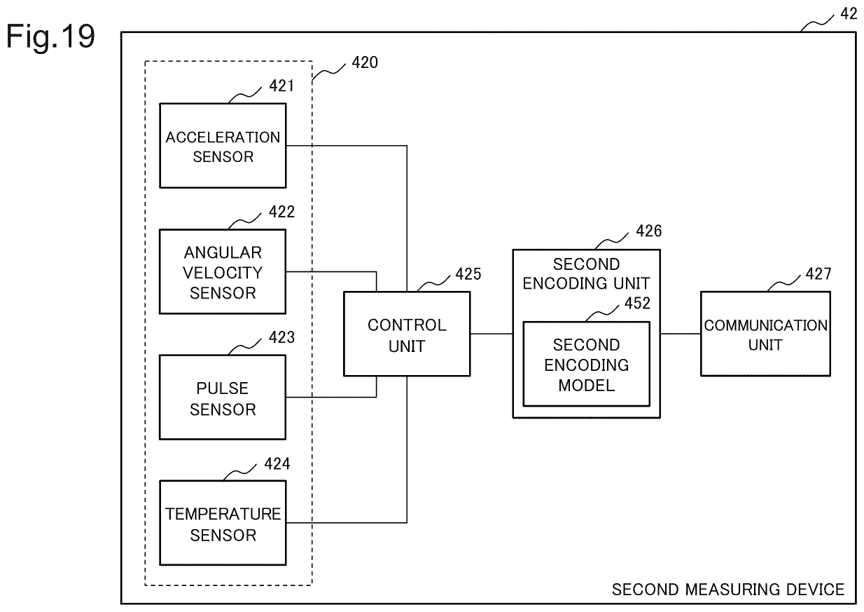

FIG. 19 is a block diagram illustrating an example of a detailed configuration of the second measuring device 42. The second measuring device 42 includes a sensor 420, a control unit 425, a second encoding unit 426, and a transmission unit 427. The sensor 420 includes an acceleration sensor 421, an angular velocity sensor 422, a pulse sensor 423, and a temperature sensor 424. The sensor 420 may include a sensor other than the acceleration sensor 421, the angular velocity sensor 422, the pulse sensor 423, and the temperature sensor 424. The second encoding unit 426 includes a second encoding model 452. The second measuring device 42 includes a real-time clock and a power supply (not illustrated).

The acceleration sensor 421 is a sensor that measures accelerations (also referred to as spatial accelerations) in three axial directions. The acceleration sensor 421 outputs the measured acceleration to the control unit 425. For example, a sensor of a piezoelectric type, a piezoresistive type, a capacitance type, or the like can be used as the acceleration sensor 421. The measurement method of the sensor used for the acceleration sensor 421 is not limited as long as the sensor can measure acceleration.

The angular velocity sensor 422 is a sensor that measures angular velocities in three axial directions (also referred to as spatial angular velocities). The angular velocity sensor 422 outputs the measured angular velocity to the control unit 425. For example, a sensor of a vibration type, a capacitance type, or the like can be used as the angular velocity sensor 422. The measurement method of the sensor used for the angular velocity sensor 422 is not limited as long as the sensor can measure the angular velocity.

The pulse sensor 423 measures the pulse of the user. For example, the pulse sensor 423 is a sensor using a photoelectric pulse wave method. For example, the pulse sensor 423 is achieved by a reflective pulse wave sensor. In the reflective pulse wave sensor, reflected light of light emitted toward a living body is received by a photodiode or a phototransistor. The reflective pulse wave sensor measures a pulse wave according to an intensity change of the received reflected light. For example, the reflective pulse wave sensor measures a pulse wave using light in an infrared, red, or green wavelength band. The light reflected in the living body is absorbed by oxygenated hemoglobin contained in the arterial blood. The reflective pulse wave sensor measures a pulse wave according to the periodicity of the blood flow rate that changes with the pulsation of the heart. For example, the pulse wave is used for evaluation of pulse rate, oxygen saturation, stress level, blood vessel age, and the like. The measurement method of the sensor used for the pulse sensor 423 is not limited as long as the sensor can measure the pulse.

The temperature sensor 424 measures the body temperature (skin temperature) of the user. For example, the temperature sensor 424 is achieved by a contact type temperature sensor such as a thermistor, a thermocouple, or a resistance temperature detector. For example, the temperature sensor 424 is achieved by a non-contact type temperature sensor such as a radiation temperature sensor or a color temperature sensor. For example, the temperature sensor 424 may be a sensor that estimates the body temperature based on a measurement value of biological data such as pulse and blood pressure. For example, the temperature sensor 424 measures the temperature of the body surface of the user. For example, the temperature sensor 424 estimates the body temperature of the user according to the temperature of the body surface of the user. The measurement method of the sensor used for the temperature sensor 424 is not limited as long as the sensor can measure the temperature.

The control unit 425 acquires accelerations in three axis directions from the acceleration sensor 421, and acquires angular velocities around the three axes from the angular velocity sensor 422. The control unit 425 acquires a pulse signal from the pulse sensor 423 and acquires a temperature signal from the temperature sensor 424. The control unit 425 converts acquired physical quantities such as acceleration and angular velocity and biological information such as a pulse signal and a temperature signal into digital data. The control unit 425 outputs the converted digital data (also referred to as second sensor data) to the second encoding unit 426. The second sensor data includes at least acceleration data, angular velocity data, pulse data, and temperature data converted into digital data. The second sensor data is associated with an acquisition time of the data. The control unit 425 may be configured to output second sensor data obtained by adding correction such as a mounting error, temperature correction, and linearity correction to the acquired acceleration data, angular velocity data, pulse data, and temperature data.

For example, the control unit 425 is a microcomputer or a microcontroller that performs overall control and data processing of the second measuring device 42. For example, the control unit 425 includes a CPU, a ROM, a flash memory, and the like. The control unit 425 controls the acceleration sensor 421 and the angular velocity sensor 422 to measure the angular velocity and the acceleration. The control unit 425 controls the pulse sensor 423 and the temperature sensor 424 to measure the pulse and the temperature. For example, the control unit 425 performs AD conversion on the angular velocity data, the acceleration data, the pulse data, and the temperature data. The control unit 425 causes the converted digital data to be stored in the flash memory. The physical quantity (analog data) measured by the acceleration sensor 421 and the angular velocity sensor 422 may be converted into digital data in each of the acceleration sensor 421 and the angular velocity sensor 422. Biological information (analog data) measured by the pulse sensor 423 and the temperature sensor 424 may be converted into digital data in each of the pulse sensor 423 and the temperature sensor 424. The digital data stored in the flash memory is output to the second encoding unit 426 at a predetermined timing.

The second encoding unit 426 acquires the second sensor data from the control unit 425. The second encoding unit 426 includes a second encoding model 452. The second encoding model 452 is a second encoding model constructed by the machine learning devices of the first to third example embodiments. For example, model parameters set by the machine learning devices of the first to third example embodiments are set in the second encoding model 452. The second encoding unit 426 inputs the acquired second sensor data to the second encoding model 452 and encodes the second sensor data into the second code. The second encoding unit 426 outputs the encoded second code to the transmission unit 427.

The transmission unit 427 acquires the second code from the second encoding unit 426. The transmission unit 427 transmits the acquired second code to the estimation device 47. The transmission unit 427 may transmit the second code to the estimation device 47 via a wire such as a cable, or may transmit the second code to the estimation device 47 via wireless communication. For example, the transmission unit 427 is configured to transmit the second code to the estimation device 47 via a wireless communication function (not illustrated) conforming to a standard such as Bluetooth (registered trademark) or WiFi (registered trademark). The communication function of the transmission unit 427 may conform to a standard other than Bluetooth (registered trademark) or WiFi (registered trademark). The transmission unit 427 also has a function of receiving data transmitted from the estimation device 47. For example, the transmission unit 427 receives update data of model parameters, universal time data, and the like from the estimation device 47. The transmission unit 427 outputs the received data to the control unit 425.

For example, the second measuring device 42 is connected to the estimation device 47 via a mobile terminal (not illustrated) carried by the user. When the communication between the second measuring device 42 and the mobile terminal is successful and the second code is transmitted from the second measuring device 42 to the mobile terminal, the measurement in the measurement time zone is ended. For example, when the communication between second measuring device 42 and the mobile terminal is successful, the clock time of second measuring device 42 may be synchronized with the clock time of the mobile terminal. When the communication between the second measuring device 42 and the mobile terminal fails and the second code is not transmitted from the second measuring device 42 to the mobile terminal, the second code in the measurement time zone only needs to be retransmitted in the next or subsequent measurement time zone. For example, when the communication between the second measuring device 42 and the mobile terminal fails, the transmission of the second code in the measurement time zone may be repeated until the communication succeeds. For example, when the communication between the second measuring device 42 and the mobile terminal fails, the transmission of the second code in the measurement time zone may be repeated within a predetermined time. The second code of the measurement time zone in which the transmission has failed only needs to be stored in a storage device (not illustrated) such as an EEPROM until the next transmission timing.

A mobile terminal (not illustrated) connected to the first measuring device 41 and the second measuring device 42 is achieved by a communication device that can be carried by a user. For example, the mobile terminal is a portable communication device having a communication function, such as a smartphone, a smart watch, or a mobile phone. When the mobile terminal is a smart watch, the second measuring device 42 may be mounted on the smart watch. The mobile terminal receives the first sensor data related to the movement of the foot of the user from the first measuring device 41. The mobile terminal receives the second sensor data related to the physical activity of the user from the second measuring device 42. The mobile terminal transmits the received code to a cloud, a server, or the like on which the estimation device 47 is mounted. The function of the estimation device 47 may be achieved by application software or the like (also referred to as an application) installed in the mobile terminal. In this case, the mobile terminal processes the received code by an application installed in the mobile terminal.

For example, when the use of the estimation system 40 of the present example embodiment is started, an application for executing the function of the estimation system 40 is downloaded to the mobile terminal of the user, and the user information is registered. For example, when the user information is registered in the first measuring device 41 or the second measuring device 42, the clock times of the first measuring device 41 and the second measuring device 42 are synchronized with the time of the mobile terminal. With such synchronization, the unique times of the first measuring device 41 and the second measuring device 42 can be set according to the universal time.

The measurement timings of the first measuring device 41 and the second measuring device 42 may be synchronized or may not be synchronized. When the time data is associated with the measurement data measured by the first measuring device 41 and the second measuring device 42, the measurement data measured by the first measuring device 41 and the second measuring device 42 can be temporally associated. Thus, it is preferable that the times of the first measuring device 41 and the second measuring device 42 are synchronized. For example, the estimation device 47 may be configured to synchronize the time difference between the first measuring device 41 and the second measuring device 42.

### [Estimation Device]

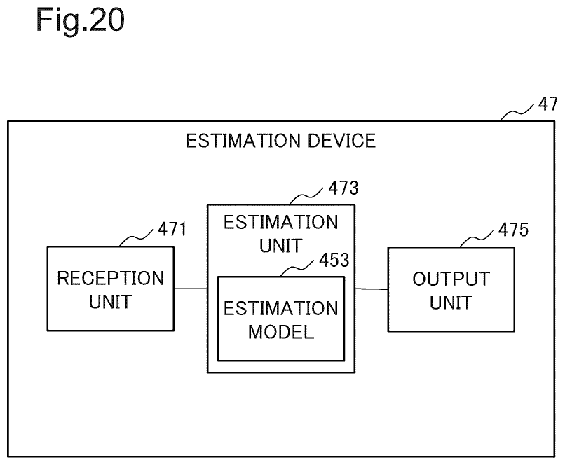

FIG. 20 is a block diagram illustrating an example of a configuration of the estimation device 47. The estimation device 47 includes a reception unit 471, an estimation unit 473, and an output unit 475. The estimation unit 473 includes an estimation model 453.

The reception unit 471 acquires the first code from the first measuring device 41. The reception unit 471 acquires the second code from the second measuring device 42. A sign is received from the first measuring device 41. The reception unit 471 outputs the received first code and second code to the estimation unit 473. For example, the reception unit 471 receives the first code from the first measuring device 41 and the first code from the second measuring device 42 via wireless communication. For example, the reception unit 471 is configured to receive the first code from the first measuring device 41 and the first code from the second measuring device 42 via a wireless communication function (not illustrated) conforming to a standard such as Bluetooth (registered trademark) or WiFi (registered trademark). The communication function of the reception unit 471 may conform to a standard other than Bluetooth (registered trademark) or WiFi (registered trademark). For example, the reception unit 471 may receive the first code from the first measuring device 41 and the first code from the second measuring device 42 via a wire such as a cable. For example, the reception unit 471 may have a function of transmitting data to the first measuring device 41 and the second measuring device 42.

The estimation unit 473 acquires the first code and the second code from the reception unit 471. The estimation unit 473 includes an estimation model 453. The estimation model 453 is an estimation model constructed by the machine learning device of the first or third example embodiment. The estimation model 453 constructed by the machine learning device of the first to third example embodiments is implemented in the estimation unit 473. Model parameters set by the machine learning devices of the first to third example embodiments are set in the estimation model 453.

The estimation unit 473 inputs the acquired first code and second code to the estimation model 453. The estimation model 453 outputs an estimation result regarding the body condition of the user in response to the input of the first code and the second code. The estimation unit 473 outputs an estimation result by the estimation model 453. For example, the estimation unit 473 estimates a score regarding the body condition of the user. For example, the score is a value obtained by indexing the evaluation regarding the body condition of the user.

For example, the estimation unit 473 estimates the body condition of the user using the first code derived from the sensor data regarding the movement of the foot measured by the first measuring device 41. For example, the body condition includes the degree of pronation/supination of the foot, the degree of progression of hallux valgus, the degree of progression of knee arthropathy, muscle strength, balance ability, flexibility of the body, and the like. For example, the estimation unit 473 estimates the physical state of the subject using physical quantities such as acceleration, velocity, trajectory (position), angular velocity, and angle measured by the first measuring device 41. The estimation by the estimation unit 473 is not particularly limited as long as the estimation relates to the body condition. The estimation unit 473 outputs the estimation result to the output unit 475.

For example, the estimation unit 473 may be configured to estimate the user's emotion using pulse data measured by the second measuring device 42. The user's emotion can be estimated by the intensity or fluctuation of the pulse. For example, the estimation device 47 estimates the degree of emotions such as delight, anger, sadness, and pleasure according to the fluctuation of the pulse time-series data. For example, the estimation device 47 may estimate the user's emotion in accordance with the variation in the baseline of the time-series data regarding the pulse. For example, when the “anger” of the user gradually increases, an upward tendency appears in the baseline according to an increase in the degree of excitement (wakefulness level) of the user. For example, when the “sadness” of the user gradually increases, a downward tendency appears in the baseline according to a decrease in the degree of excitement (wakefulness level) of the user.

The heart rate fluctuates under the influence of activity related to the autonomic nerve such as sympathetic nerve and parasympathetic nerve. Similarly, the pulse rate fluctuates under the influence of activity related to the autonomic nerve such as sympathetic nerve and parasympathetic nerve. For example, a low frequency component or a high frequency component can be extracted by frequency analysis of time-series data of the pulse rate. The influence of the sympathetic nerve and the parasympathetic nerve is reflected in the low frequency component. The influence of the parasympathetic nerve is reflected in the high frequency component. Thus, for example, the activity state of the autonomic nerve function can be estimated according to the ratio between the high frequency component and the low frequency component.

For example, the estimation device 47 estimates the user's emotion in accordance with the wakefulness level and the valence. Sympathetic nerves tend to be active when the user is excited. When the sympathetic nerve of the user becomes active, the pulsation becomes faster. That is, the larger the pulse rate, the larger the wakefulness level. Parasympathetic nerves tend to be active when the user is relaxed. When the user relaxes, the pulsation slows down. That is, the smaller the pulse rate, the smaller the wakefulness level. In this manner, the estimation device 47 can measure the wakefulness level in accordance with the pulse rate. For example, the valence can be evaluated according to the variation in the pulse interval. The more pleasant the emotional state, the more stable the emotion and the smaller the variation in the pulse interval. That is, the smaller the variation in the pulse interval, the larger the valence. On the other hand, the more unpleasant the emotional state, the more unstable the emotion, and the larger the variation in the pulse interval. That is, the larger the variation in the pulse interval, the larger the valence. In this manner, the estimation device 47 can measure the valence according to the pulse interval.

For example, the estimation device 47 estimates that the larger the valence and the wakefulness level, the larger the degree of “delight”. For example, the estimation device 47 estimates that the smaller the valence and the larger the wakefulness level, the higher the degree of “anger”. For example, the estimation device 47 estimates that the smaller the valence and the smaller the wakefulness level, the higher the degree of “sadness”. For example, the estimation device 47 estimates that the larger the valence and the smaller the wakefulness level, the higher the degree of “pleasure”. For example, the user's emotions are not classified into four emotional states such as delight, anger, sadness, and pleasure, but may be classified into more detailed emotional states.

The output unit 475 acquires the estimation result by the estimation unit 473. The output unit 475 outputs the estimation result by the estimation unit 473. For example, the output unit 475 outputs the estimation result by the estimation unit 473 to a display device (not illustrated). For example, the estimation result by the estimation unit 473 is displayed on a screen of the display device. For example, the estimation result by the estimation unit 473 is output to a system that uses the estimation result. The use of the estimation result by the estimation unit 473 is not particularly limited.

For example, the estimation device 47 is implemented in a cloud, a server, or the like (not illustrated). For example, the estimation device 47 may be achieved by an application server. For example, the estimation device 47 may be achieved by an application installed in a mobile terminal (not illustrated). For example, the estimation result by the estimation device 47 is displayed on a screen of the mobile terminal (not illustrated) or a terminal device (not illustrated) carried by the user. For example, the estimation result by the estimation device 47 is output to a system that uses the result. The use of the estimation result by the estimation device 47 is not particularly limited.

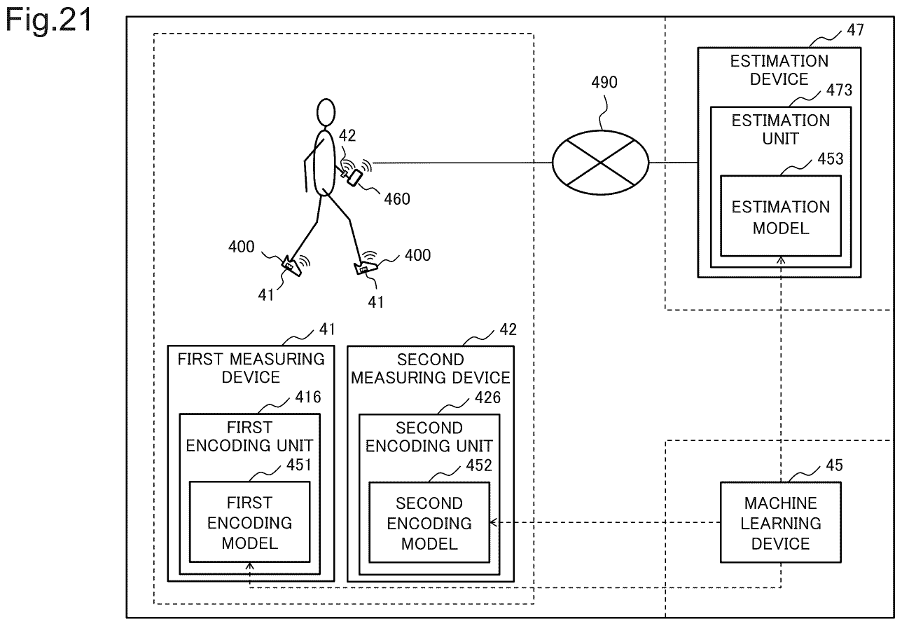

FIG. 21 is a conceptual diagram for describing setting of model parameters to a model group implemented in the estimation system 40, estimation processing of the body condition of the user by the estimation system 40, and the like. In the example of FIG. 21, the estimation device 47 and the machine learning device 45 are implemented in a cloud or a server. FIG. 21 illustrates a state in which the user walks carrying a mobile terminal 460. The first measuring device 41 is installed on the footwear 400 worn by the user. The second measuring device 42 is installed on the wrist of the user. For example, the first measuring device 41 and the second measuring device 42 are wirelessly connected to the mobile terminal 460. The mobile terminal 460 is connected to the estimation device 47 mounted on a cloud or a server via a network 490. A machine learning device 45 similar to the machine learning devices of the first to third example embodiments is mounted in a cloud or a server. For example, at the time of initial setting, at the time of updating software or the model parameters, or the like, the machine learning device 45 transmits update data of the model parameters to the first measuring device 41, the second measuring device 42, or the estimation device 47.

The first measuring device 41 measures sensor data regarding the movement of the foot, such as acceleration and angular velocity as the user walks. The first encoding unit 416 of the first measuring device 41 inputs the measured sensor data to the first encoding model 451 and encodes the sensor data into the first code. The first measuring device 41 transmits the first code obtained by encoding the sensor data to the mobile terminal 460. The first code transmitted from the first measuring device 41 is transmitted to the estimation device 47 via the mobile terminal 460 carried by the user and the network 490. When acquiring the update data of the model parameters of the first encoding model 451 from the machine learning device 45, the first measuring device 41 updates the model parameters of the first encoding model 451.

The second measuring device 42 measures sensor data related to a physical activity such as acceleration, angular velocity, pulse, or body temperature as the user walks. The second encoding unit 426 of the second measuring device 42 inputs the measured sensor data to the second encoding model 452 and encodes the sensor data into the second code. The second measuring device 42 transmits the second code obtained by encoding the sensor data to the mobile terminal 460. The second code transmitted from the second measuring device 42 is transmitted to the estimation device 47 via the mobile terminal 460 carried by the user and the network 490. When acquiring the update data of the model parameters of the second encoding model 452 from the machine learning device 45, the second measuring device 42 updates the model parameters of the second encoding model 452.

The estimation device 47 receives the first code from the first measuring device 41 via the network 490. The estimation device 47 receives the second code from the second measuring device 42 via the network 490. The estimation unit 473 of the estimation device 47 inputs the received first code and second code to the estimation model 453. The estimation model 453 outputs an estimated value related to the input of the first code and the second code. The estimation unit 473 outputs the estimation result output from the estimation model 453. For example, the estimation result output from the estimation device 47 is transmitted to the mobile terminal 460 carried by the user via the network 490. When acquiring the update data of the model parameters of the estimation model 453 from the machine learning device 45, the estimation device 47 updates the model parameters of the estimation model 453.

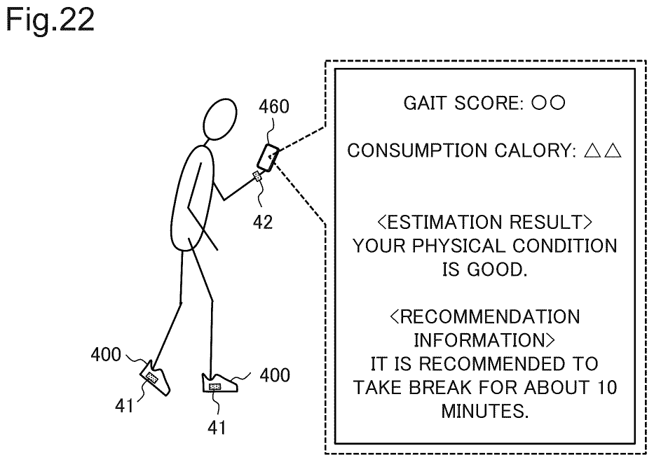

FIG. 22 illustrates an example in which the information regarding the estimation result by the estimation device 47 is displayed on a screen of the mobile terminal 460 carried by the user. In the example of FIG. 22, a gait score and an estimation result of consumed calories are displayed on the screen of the mobile terminal 460. In the example of FIG. 22, an evaluation result related to the estimation result by the estimation device 47 of “your physical condition is good” is displayed on the screen of the mobile terminal 460. Further, in the example of FIG. 22, recommendation information related to the estimation result by the estimation device 47 of “it is recommended to take a break for about 10 minutes”, is displayed on the screen of the mobile terminal 460. The user who has viewed the screen of the mobile terminal 460 can recognize the gait score regarding his/her gait and the consumed calories related to his/her physical activity. Further, the user who has viewed the screen of the mobile terminal 460 can recognize the evaluation result and the recommendation information related to the estimation result of the body condition of the user. Information such as an estimation result by the estimation device 47 and an evaluation result and recommendation information related to the estimation result only needs to be displayed on a screen visually recognizable by the user. For example, these pieces of information may be displayed on a screen of a stationary personal computer or a dedicated terminal. These pieces of information may be not character information but an image representing these pieces of information. Notification of these pieces of information may be given in a preset pattern such as sound or vibration.

### Operation

Next, operation of the estimation system 40 of the present example embodiment will be described with reference to the drawings. Hereinafter, operation of the first measuring device 41, the second measuring device 42, and the estimation device 47 will be individually described.

### [First Measuring Device]

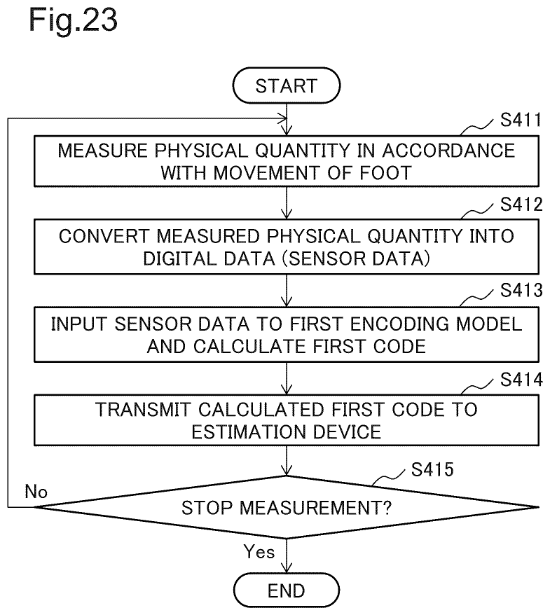

FIG. 23 is a flowchart for describing an example of the operation of the first measuring device 41. In the description along the flowchart of FIG. 23, the first measuring device 41 will be described as an operation subject.

In FIG. 23, first, the first measuring device 41 measures a physical quantity related to the movement of the foot (step S411). For example, the physical quantity related to the movement of the foot is acceleration in three axial directions or angular velocity around three axes.

Next, the first measuring device 41 converts the measured physical quantity into digital data (sensor data) (step S412).

Next, the first measuring device 41 inputs sensor data (first raw data) to the first encoding model 451 and calculates a first code (step S413).

Next, the first measuring device 41 transmits the calculated first code to the estimation device 47 (step S414).

When the measurement is stopped (Yes in step S415), the processing according to the flowchart of FIG. 23 is ended. The measurement may be stopped at a preset timing, or may be stopped according to an operation by the user. When the measurement is not stopped (No in step S415), the process returns to step S411.

Upon receiving the update data, the first measuring device 41 updates the model parameters of the first encoding model 451. The model parameters of the first encoding model 451 are set in advance and updated at timing or timing according to a request from the user.

### [Second Measuring Device]

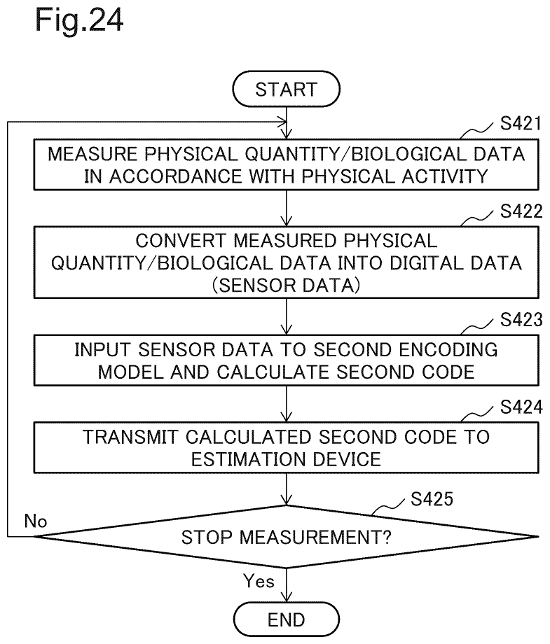

FIG. 24 is a flowchart for describing an example of the operation of the second measuring device 42. In the description along the flowchart of FIG. 24, the second measuring device 42 will be described as an operation subject.

In FIG. 24, first, second measuring device 42 measures the physical quantity/biological data related to the physical activity (step S421). For example, the physical quantity related to the physical activity is acceleration in three axial directions or angular velocity around three axes. For example, the biological data related to the physical activity is pulse data or body temperature data.

Next, the second measuring device 42 converts the measured physical quantity/biological data into digital data (sensor data) (step S422).

Next, the second measuring device 42 inputs sensor data (second raw data) to the second encoding model 452 and calculates a second code (step S423).

Next, the second measuring device 42 transmits the calculated second code to the estimation device 47 (step S424).

When the measurement is stopped (Yes in step S425), the processing according to the flowchart of FIG. 24 is ended. The measurement may be stopped at a preset timing, or may be stopped according to an operation by the user. When the measurement is not stopped (No in step S425), the process returns to step S411.

Upon receiving the update data, the second measuring device 42 updates the model parameters of the second encoding model 452. The model parameters of the second encoding model 452 are set in advance and updated at timing or timing according to a request from the user.

### [Estimation Device]

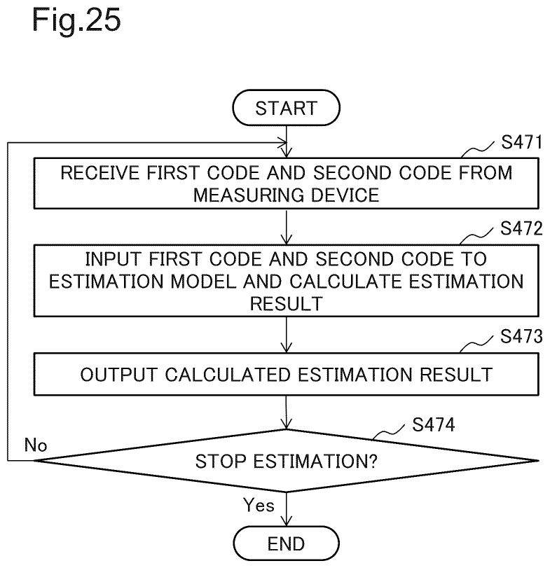

FIG. 25 is a flowchart for describing an example of the operation of the estimation device 47. In the description along the flowchart of FIG. 25, the estimation device 47 will be described as an operation subject.

In FIG. 25, first, the estimation device 47 receives the first code and the second code from each of the first measuring device 41 and the second measuring device 42 (step S471).

Next, the estimation device 47 inputs the first code and the second code to the estimation model 453 and calculates an estimation result (step S472).

Next, the estimation device 47 outputs the calculated estimation result (step S473).

When the estimation is stopped (Yes in step S474), the processing along the flowchart in FIG. 25 is ended. The estimation may be stopped at a preset timing, or may be stopped according to an operation by the user. When the estimation is not stopped (No in step S474), the process returns to step S471.

Upon receiving the update data, the estimation device 47 updates the model parameters of the estimation model 453. The model parameters of the estimation model 453 are set in advance and updated at timing or timing according to a request by the user.

As described above, the estimation system of the present example embodiment includes the first measuring device, the second measuring device, and the estimation device. The first measuring device includes at least one first sensor. The first measuring device inputs first sensor data measured by the first sensor to the first encoding model. The first measuring device transmits the first code output from the first encoding model in response to the input of the first sensor data. The second measuring device includes at least one second sensor. The second measuring device inputs the second sensor data measured by the second sensor to the second encoding model. The second measuring device transmits the second code output from the second encoding model in response to the input of the second sensor data. The estimation device includes an estimation model. The estimation device receives the first code transmitted from the first measuring device and the second code transmitted from the second measuring device. The estimation device inputs the received first code and second code to the estimation model. The estimation device outputs an estimation result output from the estimation model in response to the input of the first code and the second code.

The estimation system of the present example embodiment includes the first encoding model, the second encoding model, and the estimation model constructed by the machine learning devices of the first to third example embodiments. According to the present example embodiment, since the codes encoded by the first encoding model and the second encoding model are communicated, the amount of data in communication can be reduced. That is, according to the present example embodiment, since the redundancy of the code derived from the sensor data measured by the plurality of measuring instruments is eliminated, the communication capacity between the first measuring device and the second measuring device and the estimation device can be reduced.

In one aspect of the present example embodiment, the first measuring device and the second measuring device are worn on different body parts of the user who is an estimation target of the body condition. According to the present aspect, it is possible to eliminate the redundancy of the sensor data measured by the first measuring device and the second measuring device worn on different body parts such as a foot portion and a wrist, and to efficiently reduce the dimensions of the sensor data.

In one aspect of the present example embodiment, the first measuring device and the second measuring device are worn on a pair of body parts of the user who is an estimation target of the body condition. According to the present aspect, it is possible to eliminate redundancy of sensor data measured by the first measuring device and the second measuring device worn on the pair of body parts, such as the left and right foot portions or wrists, and to efficiently reduce the dimensions of the sensor data.

In one aspect of the present example embodiment, the estimation device transmits information regarding the estimation result to a terminal device having a screen visually recognizable by the user. For example, the information regarding the estimation result transmitted to the portable device is displayed on the screen of the mobile terminal. The user who has visually recognized the information regarding the estimation result displayed on the screen of the mobile terminal can recognize the estimation result.

In the present example embodiment, an example has been described in which the encoding model is mounted on each of the two measuring devices. The encoding model may be mounted on any one of the two measuring devices. It is difficult for a general-purpose measuring device (referred to as a second measuring device) to change an internal algorithm. Thus, the first encoding model included in the first measuring device only needs to be trained using the method of the first example embodiment in such a way that the data of the general-purpose second measuring device cannot be estimated from the first measuring device whose internal algorithm can be changed. In the present example embodiment, an example has been described in which the estimation system includes two measuring devices. The estimation system of the present example embodiment may include three or more measuring devices.

In the present example embodiment, an example has been described in which the first measuring device 41 is installed on the foot portion and the second measuring device 42 is installed on the wrist. In such a case, the foot portion corresponds to the first portion, and the wrist corresponds to the second portion. For example, the first measuring device 41 may be installed on the right foot portion, and the second measuring device 42 may be installed on the left foot portion. In such a case, one of the right foot portion and the left foot portion corresponds to the first portion, and the other corresponds to the second portion. For example, the first measuring device 41 may be installed on the right wrist, and the second measuring device 42 may be installed on the left wrist.

In such a case, one of the right wrist and the left wrist corresponds to the first portion, and the other corresponds to the second portion. The wearing portions of the first measuring device 41 and the second measuring device 42 are not limited to the foot portion and the appropriate portion. The first measuring device 41 and the second measuring device 42 only need to be worn on a body part to be measured.

### Hardware

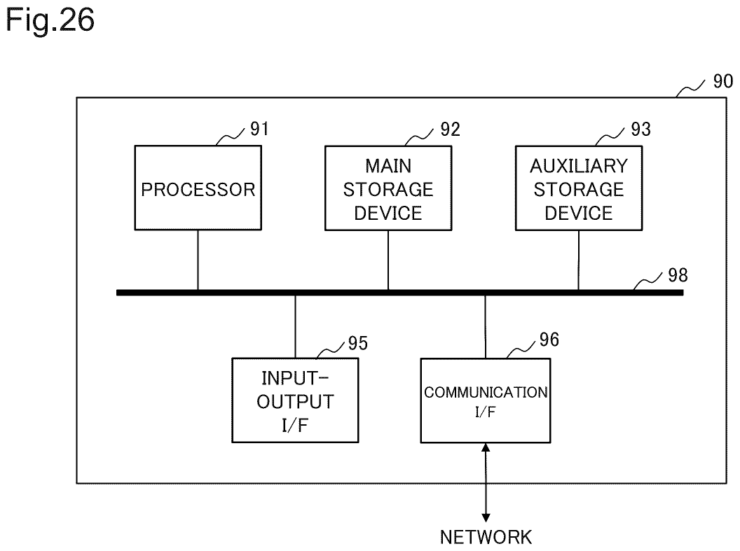

Here, a hardware configuration for executing processing of the machine learning device and the estimation device according to each example embodiment of the present disclosure will be described using an information processing device 90 of FIG. 26 as an example. The information processing device 90 in FIG. 26 is a configuration example for executing processing of the machine learning device and the estimation device of each example embodiment, and does not limit the scope of the present disclosure.

As illustrated in FIG. 26, the information processing device 90 includes a processor 91, a main storage device 92, an auxiliary storage device 93, an input-output interface 95, and a communication interface 96. In FIG. 26, the interface is abbreviated as an interface (I/F). The processor 91, the main storage device 92, the auxiliary storage device 93, the input-output interface 95, and the communication interface 96 are data-communicably connected to each other via a bus 98. The processor 91, the main storage device 92, the auxiliary storage device 93, and the input-output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, it is only required to use a software program installed in the information processing device 90. The processor 91 executes processing by the machine learning device and the estimation device according to the present example embodiment.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magnetoresistive random access memory (MRAM) may be configured and added as the main storage device 92.

The auxiliary storage device 93 stores various data such as programs. The auxiliary storage device 93 is implemented by a local disk such as a hard disk or a flash memory. The main storage device 92 may be configured to store various data, and the auxiliary storage device 93 may be omitted.

The input-output interface 95 is an interface for connecting the information processing device 90 and a peripheral device based on a standard or a specification. The communication interface 96 is an interface for connecting to an external system or device through a network such as the Internet or an intranet based on a standard or a specification. The input-output interface 95 and the communication interface 96 may be shared as an interface connected to an external device.

Input devices such as a keyboard, a mouse, and a touch panel may be connected to the information processing device 90 as necessary. These input devices are used to input information and settings. In a case where the touch panel is used as the input device, the display screen of the display device may also serve as the interface of the input device. Data communication between the processor 91 and the input device is only required to be mediated by the input-output interface 95.

The information processing device 90 may be provided with a display device for displaying information. In a case where a display device is provided, the information processing device 90 preferably includes a display control device (not illustrated) for controlling display of the display device. The display device is only required to be connected to the information processing device 90 via the input-output interface 95.

The information processing device 90 may be provided with a drive device. The drive device mediates reading of data and a program from a recording medium, writing of a processing result of the information processing device 90 to the recording medium, and the like between the processor 91 and the recording medium (program recording medium). The drive device only needs to be connected to the information processing device 90 via the input-output interface 95.

The above is an example of a hardware configuration for enabling the machine learning device and the estimation device according to each example embodiment of the present invention. The hardware configuration of FIG. 26 is an example of a hardware configuration for executing arithmetic processing of the machine learning device and the estimation device according to each example embodiment, and does not limit the scope of the present invention. A program for causing a computer to execute processing related to the machine learning device and the estimation device according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or another recording medium. When a program executed by the processor is recorded in a recording medium, the recording medium corresponds to a program recording medium.

The components of the machine learning device and the estimation device of each example embodiment may be combined in any manner.

The components of the machine learning device and the estimation device of each example embodiment may be achieved by software or may be achieved by a circuit.

While the present invention has been particularly illustrated and described with reference to example embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

10, 20, 30, 45 machine learning device
11,21, 31 acquisition unit
12, 22, 32 encoding unit
13, 23, 33 estimation unit
14, 24, 34 adversarial estimation unit
15, 25, 35 machine learning processing unit
17 database
40 estimation system
41 first measuring device
42 second measuring device
47 estimation device
111 first measuring device
112 second measuring device
121, 221 first encoding unit
122, 222 second encoding unit
151, 251, 451 first encoding model
152, 252, 452 second encoding model
153, 253, 453 estimation model
154 adversarial estimation model
241 first adversarial estimation unit
242 second adversarial estimation unit
254 first adversarial estimation model
255 second adversarial estimation model
410, 420 sensor
411, 421 acceleration sensor
412, 422 angular velocity sensor
415, 425 control unit
416 first encoding unit
417, 427 transmission unit
423 pulse sensor
424 temperature sensor
426 second encoding unit
471 reception unit
473 estimation unit
475 output unit

What is claimed is:

1. A machine learning device comprising:
a memory storing instructions; and
a processor connected to the memory and configured to execute the instructions to:
acquire a training data set including first sensor data measured by a first measuring device, second sensor data measured by a second measuring device, and correct answer data;
encode the first sensor data into a first code using a first encoding model and encode the second sensor data into a second code using a second encoding model;
input the first code and the second code to an estimation model and output an estimation result output from the estimation model;
an adversarial estimation means configured to input the first code to a first adversarial estimation model that outputs an estimated value of the second code in response to input of the first code and estimate the estimated value of the second code; and
train the first encoding model, the second encoding model, the estimation model, and the first adversarial estimation model by machine learning;
train the first encoding model, the second encoding model, and the estimation model in such a way that an estimation result of the estimation model matches the correct answer data;
train the first adversarial estimation model in such a way that the estimated value of the second code by the first adversarial estimation model matches the second code output from the second encoding model; and
train the first encoding model in such a way that the estimated value of the second code by the first adversarial estimation model does not match the second code output from the second encoding model.

2. The machine learning device according to claim 1, wherein
the processor is configured to execute the instructions to
train the first encoding model, the second encoding model, and the estimation model in such a way that an error between the estimation result of the estimation model and the correct answer data decreases,
train the first adversarial estimation model in such a way that an error between the estimated value of the second code by the first adversarial estimation model and the second code output from the second encoding model decreases, and
train the first encoding model in such a way that an error between the estimated value of the second code by the first adversarial estimation model and the second code output from the second encoding model increases.

3. The machine learning device according to claim 1, wherein
the processor is configured to execute the instructions to
input the second code to a second adversarial estimation model that outputs an estimated value of the first code in response to input of the second code, and estimate the estimated value of the first code,
train the second adversarial estimation model in such a way that the estimated value of the first code by the second adversarial estimation model matches the first code output from the first encoding model, and
train the second encoding model in such a way that the estimated value of the first code by the second adversarial estimation model does not match the first code output from the first encoding model.

4. The machine learning device according to claim 3, wherein
the processor is configured to execute the instructions to
train the second adversarial estimation model in such a way that an error between the estimated value of the first code by the second adversarial estimation model and the first code output from the first encoding model decreases, and
train the second encoding model in such a way that an error between the estimated value of the first code by the second adversarial estimation model and the first code output from the first encoding model increases.

5. An estimation system in which a first encoding model, a second encoding model, and an estimation model constructed by the machine learning device according to claim 1 is implemented, the estimation system comprising:
a first measuring device including
at least one first sensor,
a memory storing instructions, and
a processor connected to the memory and configured to execute the instructions to
input first sensor data measured by the first sensor to the first encoding model, and
transmit a first code output from the first encoding model in response to input of the first sensor data;
a second measuring device including
at least one second sensor,
a memory storing instructions, and
a processor connected to the memory and configured to execute the instructions to
input second sensor data measured by the second sensor to the second encoding model, and
transmit a second code output from the second encoding model in response to input of the second sensor data; and
an estimation device including the estimation model, the estimation device is configured to
a memory storing instructions, and
a processor connected to the memory and configured to execute the instructions to
receive the first code transmitted from the first measuring device and the
second code transmitted from the second measuring device,
input the received first code and second code to the estimation model, and output an estimation result output from the estimation model in response to input of the first code and the second code.

6. The estimation system according to claim 5, wherein
the first measuring device and the second measuring device are configured to be worn on different body parts of a user who is an estimation target of a body condition.

7. The estimation system according to claim 5, wherein
the first measuring device and the second measuring device are configured to be worn on a pair of body parts of a user who is an estimation target of a body condition.

8. The estimation system according to claim 6, wherein
the processor included in the estimation device is configured to execute the instructions to
transmit recommendation information regarding the estimation result to a terminal device having a screen visually recognizable by the user, and wherein
the recommendation information is information that supports the user for making decision about taking an action for the body condition of the user.

9. A training method for a computer to perform:
acquiring a training data set including first sensor data measured by a first measuring device, second sensor data measured by a second measuring device, and correct answer data;
encoding the first sensor data into a first code using a first encoding model and encoding the second sensor data into a second code using a second encoding model;
inputting the first code and the second code to an estimation model and outputting an estimation result output from the estimation model;
inputting the first code to a first adversarial estimation model that outputs an estimated value of the second code in response to input of the first code and estimating the estimated value of the second code;
training the first encoding model, the second encoding model, and the estimation model in such a way that an estimation result of the estimation model matches the correct answer data;
training the first adversarial estimation model in such a way that the estimated value of the second code by the first adversarial estimation model matches the second code output from the second encoding model; and
training the first encoding model in such a way that the estimated value of the second code by the first adversarial estimation model does not match the second code output from the second encoding model.

10. A non-transitory recording medium on which a program is recorded for causing a computer to execute:
a process of acquiring a training data set including first sensor data measured by a first measuring device, second sensor data measured by a second measuring device, and correct answer data;
a process of encoding the first sensor data into a first code using a first encoding model and encoding the second sensor data into a second code using a second encoding model;
a process of inputting the first code and the second code to an estimation model and outputting an estimation result output from the estimation model;
a process of inputting the first code to a first adversarial estimation model that outputs an estimated value of the second code in response to input of the first code and estimating the estimated value of the second code;
a process of training the first encoding model, the second encoding model, and the estimation model in such a way that an estimation result of the estimation model matches the correct answer data;
a process of training the first adversarial estimation model in such a way that the estimated value of the second code by the first adversarial estimation model matches the second code output from the second encoding model; and
a process of training the first encoding model in such a way that the estimated value of the second code by the first adversarial estimation model does not match the second code output from the second encoding model.
